(19) United States
(12) Patent Application Publication
(10) Pub. No.: US 2026/0202643 A1
(43) Pub. Date: Jul. 16, 2026

(54) OPTICAL SYSTEM AND CAMERA DEVICE COMPRISING SAME

(71) Applicant: LG INNOTEK CO., LTD., Seoul (KR)

(72) Inventor: Ju Yong SHIM, Seoul (KR)

(21) Appl. No.: 19/134,081

(22) PCT Filed: Nov. 28, 2023
(86) PCT No.: PCT/KR2023/019380

§ 371 Date: May 29, 2025

(30) Foreign Application Priority Data
Nov. 29, 2022 (KR) 10-2022-0162721

(51) Int. Cl. G02B 9/62; G02B 13/00

(52) U.S. Cl. CPC G02B 9/62; G02B 13/0045

(57) ABSTRACT

An optical system according to an embodiment of the present invention comprises first to sixth lens arranged sequentially from an object side to an image side, and an image sensor, wherein the first lens has negative power, the second lens has negative power, the third lens has positive power, the fourth lens has positive power, the fifth lens has negative power, the sixth lens has positive power, an aperture is disposed between the third lens and the fourth lens, the first to third lenses have negative composite power, and the fourth and sixth lenses have positive composite power.

### TECHNICAL FIELD

Embodiments of the present invention relate to an optical system and a camera device including the same.

### BACKGROUND ART

An advanced driving assistance system (ADAS) is an advanced driver assistance system that assists a driver in driving, and senses the situation in front of a vehicle, determines the situation based on the sensed results, and controls the behavior of the vehicle based on the determined situation. For example, an ADAS sensor device detects a preceding vehicle and recognizes a lane. Afterward, once the target lane, target speed, and preceding target are determined, the electrical stability control (ESC), engine management system (EMS), motor driven power steering (MDPS), and the like of the vehicle are controlled. Representatively, the ADAS may be implemented as an automatic parking system, a low-speed city driving assistance system, a blind spot warning system, and the like.

An ADAS sensor device includes a GPS sensor, a laser scanner, a forward radar, a lidar, or the like, and the most representative ADAS sensor device is a camera for capturing the front, rear, and sides of the vehicle.

A camera may be disposed outside or inside the vehicle to detect the surroundings of the vehicle. Additionally, the camera may be disposed inside the vehicle to detect the situation of a driver and a passenger. For example, the camera may capture the driver from a location adjacent to the driver and detect the driver's health conditions, whether he or she is drowsy, whether he or she has been drinking, and the like. In addition, the camera may capture the passenger from a location adjacent to the passenger, detect whether the passenger is sleeping, the passenger's health conditions, and the like, and provide information about the passenger to the driver.

The most important element for obtaining an image in a camera is an imaging lens that forms the image. Recently, interest in high performance such as high definition and high resolution has been increasing, and research on an optical system including a plurality of lenses is being conducted to achieve this. However, there is a problem that the characteristics of the optical system change when the camera is exposed to harsh environments, such as, for example, high temperature, low temperature, moisture, and high humidity, inside or outside the vehicle. In this case, it may be difficult for the camera to obtain excellent optical characteristics and aberration characteristics uniformly.

### DISCLOSURE

### Technical Problem

The technical problem to be solved by the present invention is to provide an optical system having improved optical characteristics and a camera device including the same.

Another technical problem to be solved by the present invention is to provide an optical system having excellent optical performance in low-temperature to high-temperature environments and a camera device including the same.

Still another technical problem to be solved by the present invention is to provide an optical system capable of preventing or minimizing changes in optical characteristics in various temperature ranges and a camera device including the same.

### Technical Solution

An optical system according to an embodiment of the present invention includes first to sixth lenses disposed sequentially from an object side to an image side and an image sensor, wherein the first lens has negative power, the second lens has negative power, the third lens has positive power, the fourth lens has positive power, the fifth lens has negative power, and the sixth lens has positive power, an aperture is disposed between the third lens and the fourth lens, the first to third lenses have negative composite power, and the fourth to sixth lenses have positive composite power.

An image-side surface of the third lens may be concave, and an object-side surface of the fourth lens may be concave.

A ratio (R6/R7) of a radius of curvature R6 of the image-side surface of the third lens to a radius of curvature R7 of the object-side surface of the fourth lens may be −3 or less.

An effective diameter of an object-side surface of the first lens may be 8 mm or more and 9.5 mm or less.

The effective diameter of the object-side surface of the first lens may be greater than a diagonal length of the image sensor, and an effective diameter of an image-side surface of the first lens may be smaller than the diagonal length of the image sensor.

A ratio of the effective diameter of the object-side surface of the first lens to the diagonal length of the image sensor may be 1.05 or more and 1.3 or less, and a ratio of the effective diameter of the image-side surface of the first lens to the diagonal length of the image sensor may be 0.4 to 0.7.

At least one of the object-side surface and the image-side surface of the second lens may include a critical point having an inclination angle of 0, and an inclination angle of the image-side surface of the first lens in a region that is four times or more a distance from an optical axis to the critical point may be 30 degrees or more.

A ratio of an edge thickness to a center thickness of the first lens may be 1.2 or more and 3 or less.

Among a first distance between the first lens and the second lens, a second distance between the second lens and the third lens, a third distance between the third lens and the fourth lens, a fourth distance between the fourth lens and the fifth lens, and a fifth distance between the fifth lens and the sixth lens, the second distance may be the smallest.

The fourth distance is the next smallest distance after the second distance.

A ratio (BFL/TTL) of a BFL to TTL may be 0.35 to 0.5.

A ratio (R1/R2) of a radius of curvature R1 of the object-side surface of the first lens to a radius of curvature R2 of the image-side surface thereof may be 3 to 4.5.

### Advantageous Effects

An optical system and a camera device including the same according to embodiments of the present invention can have improved optical characteristics. In the optical system according to the embodiments of the present invention, a plurality of lenses can have set thicknesses, refractive powers, and distances between adjacent lenses. Accordingly, the optical system according to the embodiments of the present invention and the camera device including the same can have improved MTF characteristics, aberration control characteristics, resolution characteristics, etc. in a set field of view range, and can have excellent optical performance in the periphery of the field of view.

In addition, the optical system according to the embodiments of the present invention and the camera device including the same can have excellent optical performance in a low temperature to high temperature range (−40° C. to 105° C.). Specifically, the plurality of lenses included in the optical system can have set materials, refractive powers, and refractive indices. Accordingly, when the refractive index of each lens changes due to temperature changes, and thus the focal length of each lens changes, mutual compensation can be made by a plastic lens and a glass lens. That is, the optical system can effectively perform distribution of refractive power in a low to high temperature range and prevent or minimize changes in optical characteristics in the low to high temperature range. Therefore, the optical system according to the embodiments and the camera device including the same can maintain improved optical characteristics in various temperature ranges.

In addition, the optical system according to the embodiments and the camera device including the same can satisfy the set field of view and implement excellent optical characteristics through a combination of a plastic lens and a glass lens. Thus, the optical system can provide a slimmer vehicle camera module. Accordingly, the optical system and the camera device including the same can be provided for various applications, devices and the like and can have excellent optical characteristics even when exposed to harsh temperature environments, for example, the outside of a vehicle, or inside the vehicle at high temperatures in the summer.

### DESCRIPTION OF DRAWINGS

FIGS. 1 and 2 show an optical system according to an embodiment of the present invention.

FIG. 3 shows the characteristics of the optical system according to the embodiment of the present invention.

FIG. 4 shows an aspherical coefficient of an aspherical lens in the optical system according to the embodiment of the present invention.

FIG. 5 is design data showing distances between lens surfaces according to distances in a Y direction from an optical axis in the optical system according to the embodiment of the present invention.

FIG. 6 is design data showing sag values of lens surfaces according to distances in the Y direction from the optical axis in first to sixth lenses of the optical system according to the embodiment of the present invention.

FIG. 7 is design data showing inclination angles of lens surfaces according to distances in the Y direction from the optical axis in the optical system according to the embodiment of the present invention.

FIG. 8 is a graph showing RI data according to a position of an image sensor in the optical system according to the embodiment of the present invention.

FIGS. 9 to 11 are graphs showing data on a diffraction modulation transfer function (MTF) of visible light at room temperature, low temperature, and high temperature in the optical system of FIG. 1.

FIGS. 12 to 14 are graphs showing data on the diffraction modulation transfer function (MTF) of IR light at room temperature, low temperature, and high temperature in the optical system of FIG. 1.

FIG. 15 is an example of a plan view of a vehicle to which the optical system according to the embodiment of the invention or the camera device including the same is applied.

### MODES OF THE INVENTION

Hereinafter, preferred embodiments of the present invention will be described in detail with reference to the attached drawings.

However, the technical idea of the present invention is not limited to some of the embodiments described, but can be implemented in various different forms, and within the scope of the technical idea of the present invention, one or more of the components among the embodiments can be selectively combined or substituted and used.

In addition, terms (including technical and scientific terms) used in the embodiments of the present invention can be interpreted as having a meaning that can be generally understood by a person of ordinary skill in the technical field to which the present invention belongs, unless explicitly and specifically defined and described, and terms that are commonly used, such as terms defined in a dictionary, can be interpreted in consideration of the contextual meaning of the relevant technology.

Additionally, the terms used in the embodiments of the present invention are for the purpose of describing the embodiments and are not intended to limit the present invention.

In this specification, the singular may also include the plural unless specifically stated otherwise in the phrase, and when it is described as “at least one (or one or more) of A, B, and C,” it may include one or more of all combinations in which A, B, and C can be combined.

Additionally, in describing components of embodiments of the present invention, terms such as first, second, A, B, (a), (b), etc. may be used.

These terms are only intended to distinguish one component from another, and the nature, order, sequence, etc. of the component are not limited by these terms.

Further, when a certain component is described as being ‘connected,’ ‘coupled,’ or ‘joined’ to another component, it may include not only cases where the component is directly connected, coupled, or joined to the other component, but also cases where the component is ‘connected,’ ‘coupled,’ or ‘joined’ by still another component between the component and the other component.

Additionally, when one component is described as being formed or disposed “above (upper) or below (lower)” another component, above (upper) or below (lower) includes not only cases where the two components are in direct contact with each other, but also cases where one or more still other components are formed or disposed between the two components. Additionally, when expressed as “above (upper) or below (lower),” it may include the meaning of not only the upward direction but also the downward direction based on one component.

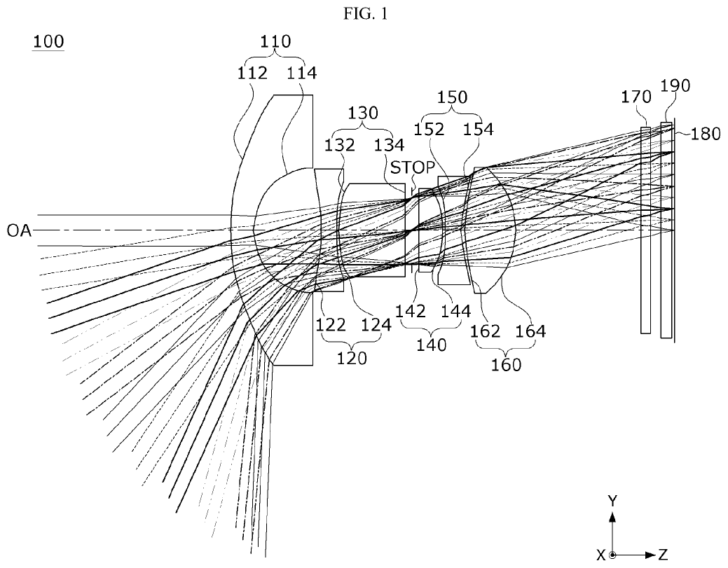

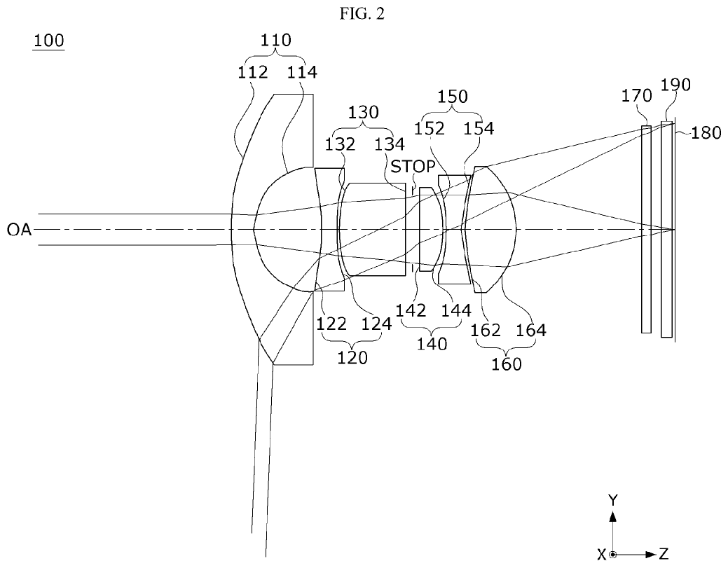

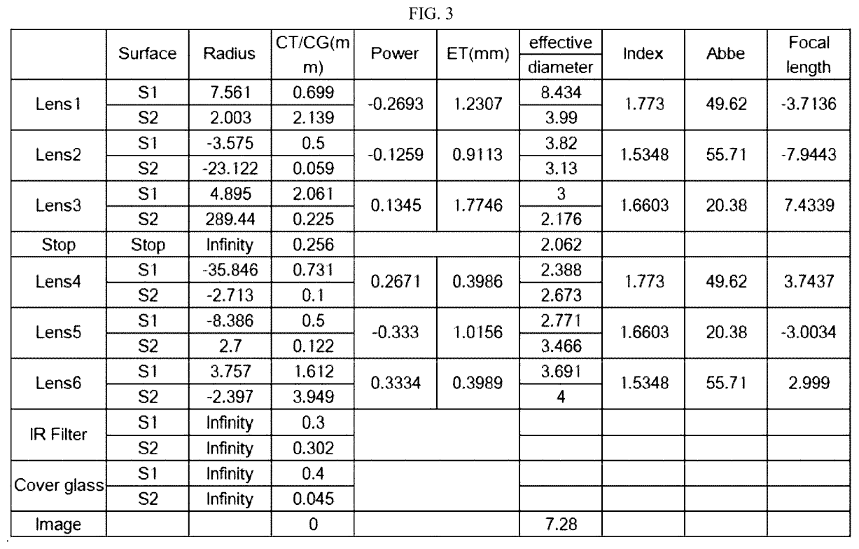

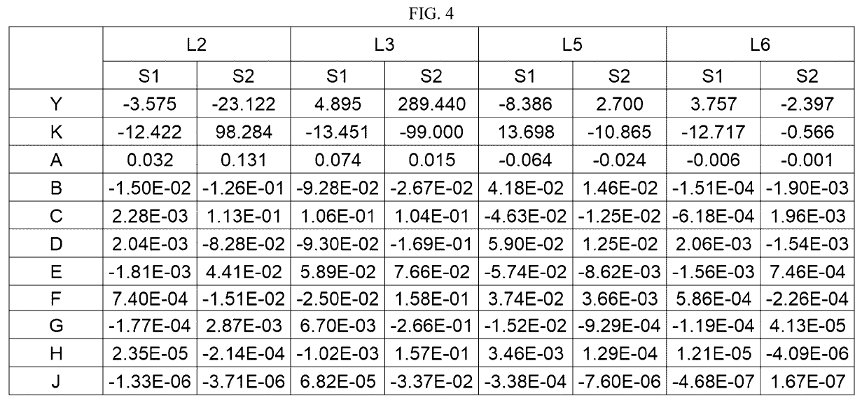

FIGS. 1 and 2 show an optical system according to an embodiment of the present invention. Here, a Z direction is a direction of an optical axis, an X direction is a direction perpendicular to the direction of the optical axis and parallel to one side of an image sensor, and a Y direction is a direction perpendicular to the direction of the optical axis and the X direction. Hereinafter, an example in which an X-axis length to a Y-axis length of the image sensor is 4 to 3 is described, but is not limited thereto. FIG. 3 shows the characteristics of the optical system according to the embodiment of the present invention, and FIG. 4 shows an aspherical coefficient of an aspherical lens in the optical system according to the embodiment of the present invention.

Referring to FIGS. 1 and 2, an optical system 100 according to the embodiment of the present invention may include a first lens 110, a second lens 120, a third lens 130, a fourth lens 140, a fifth lens 150, a sixth lens 160, a filter 170, and an image sensor 180 that are sequentially disposed from an object side to an image side.

Although not shown, a right-angled prism may be further disposed at a front end of the first lens 110.

At least one of the first lens 110, the second lens 120, the third lens 130, the fourth lens 140, the fifth lens 150, and the sixth lens 160 may include an effective region and an ineffective region. The effective region may be a region through which light incident on the lens passes, that is, a region where the incident light is refracted and optical properties are implemented. In this specification, an effective diameter may mean the diameter of the effective area where effective light is incident on each surface of each lens. In this specification, a numerical value of the effective diameter may have a certain error range. For example, for the numerical value of the effective diameter presented in this specification, a range of ±0.4 mm can be regarded as an effective region, and for the numerical value of the effective diameter presented in this specification, the range of ±0.4 mm may be interpreted as the effective diameter. The ineffective region may be disposed around the effective region and may be a region where light is not incident, that is, a region that is irrelevant to optical properties. The ineffective region may be a region that is fixed to a barrel or the like accommodating a lens. In this specification, the diameter of the lens may be a diameter of the entire lens including a flange portion of the lens in addition to the effective region of the lens. Although a flange of the lens is not shown in this specification, the flange may be a portion that is formed to protrude in a direction perpendicular to the optical axis from the side surface of the lens so that the lens is coupled to the barrel. Effective light may not be incident on the flange. A spacer may be additionally disposed between flanges of different lenses so that the lens is coupled to the barrel.

According to the embodiment of the present invention, the filter 170 and the image sensor 180 may be sequentially disposed at a rear end of the sixth lens 160. At this time, the filter 170 may be a filter through which visible light is transmitted and which blocks infrared (IR) light. Accordingly, the filter 170 may block near-infrared light, for example, light having a wavelength of 700 nm to 1100 nm, from light incident on the optical system 100. Accordingly, it is possible to block radiant heat emitted from external light from being transmitted to the image sensor 180. Alternatively, the filter 170 may be a filter through which IR light is transmitted and which blocks visible light.

The filter 170 may be disposed between the sixth lens 160 and the image sensor 180.

The image sensor 180 may be coupled to a printed circuit board. The image sensor 180 may detect light and convert the detected light into an electrical signal. The image sensor 180 may detect light that sequentially passes through the first to sixth lenses. The image sensor 180 may include a device capable of detecting incident light, such as a charge coupled device (CCD) or a complementary metal oxide semiconductor (CMOS).

A cover glass 190 may be disposed between the filter 170 and the image sensor 180, may protect an upper portion of the image sensor 180, and may prevent a decrease in the reliability of the image sensor 180. The cover glass 190 may be omitted. The cover glass 190 may be protective glass.

According to the embodiment of the present invention, the first lens 110, the second lens 120, the third lens 130, the fourth lens 140, the fifth lens 150, and the sixth lens 160 are sequentially disposed along the optical axis.

In this specification, an “object-side surface” may mean a surface of the lens facing an object side with respect to an optical axis OA, and an “image-side surface” may mean a surface of the lens facing an imaging surface, that is, the image sensor with respect to the optical axis. One surface of the lens that is convex may mean a convex shape in the optical axis or paraxial region, and one surface of the lens that is concave may mean a concave shape in the optical axis or paraxial region. The paraxial region means a very narrow region near the optical axis and is a region where a distance from light to the optical axis OA is almost 0. Hereinafter, the meaning of the optical axis may include the center of each lens or the very narrow region near the optical axis. The radius of curvature, center thickness, and an optical axis gap between lenses listed in the table for lens data may refer to values on the optical axis (units: mm). A vertical direction may mean the direction perpendicular to the optical axis, and an end of a lens or lens surface may mean an end of the effective region of the lens through which incident light passes.

According to the embodiment of the present invention, the optical system 100 and a camera device including the same may be mounted inside or outside a vehicle to monitor a driver or sense external objects or lanes. The material of the lenses may be selected from glass or plastic, and the coefficient of linear expansion of glass material may be smaller than that of plastic material. Accordingly, a glass lens may be employed to suppress changes in the focal point imaging position due to temperature changes. However, since a glass lens is more expensive than a plastic lens, there is a problem that it is difficult to satisfy the demand for lower costs. Thus, a configuration in which the glass lens and the plastic lens are mixed in the optical system 100 is required. When the optical system 100 includes a plastic lens, weight reduction and cost reduction may be realized, and excellent correction for various aberrations such as spherical aberration and chromatic aberration is possible due to the plastic lens. Additionally, since plastic lenses may provide aspherical lenses, it is possible to minimize distortion in the periphery.

The optical system 100 may include n lenses, an n^{th} lens may be the last lens adjacent to the image sensor 180, and an n−1^{th} lens may be a lens that is closest to the last lens. n is an integer of 6 or more, for example, 6 to 8. The n lenses may have a ratio of lenses made of plastic and lenses made of glass in the range of 2:3 to 2:6 or in the range of 3:4 to 3:5.

In the embodiment of the present invention, the optical system 100 may include a plurality of lens groups LG1 and LG2, and each of the plurality of lens groups LG1 and LG2 may include at least one lens. For example, the optical system 100 may include a first lens group LG1 and a second lens group LG2 sequentially disposed along the optical axis OA from an object side toward the image sensor 180.

The number of lenses in each of the first lens group LG1 and the second lens group LG2 may be the same or different. For example, the first lens group LG1 may include three lenses, and the second lens group LG2 may include three lenses. For example, the first lens group LG1 may include first to third lenses 110, 120, and 130, and the second lens group LG2 may include fourth to sixth lenses 140, 150, and 160.

The first lens group LG1 may include at least one glass lens and at least one plastic lens. In the first lens group LG1, the lens that is closest to the object side, that is, the first lens 110, may be a glass lens. The glass lens has a small amount of changes in expansion and contraction due to external temperature changes, and its surface is not easily scratched, thereby preventing surface damage.

The second lens group LG2 may include at least one glass lens and at least one plastic lens. In the second lens group LG2, the lens that is closest to the object side, that is, the fourth lens 140, may be a glass lens.

The rate of change in contraction and expansion of a glass material due to temperature changes is smaller than the rate of change in contraction and expansion of a plastic material due to temperature changes. Thus, the lens that is closest to the outside in the first lens group LG1 and the lens that is closest to the outside in the second lens group LG2 may be made of a glass material.

According to the embodiment of the present invention, the lenses made of a plastic material may be disposed continuously in the first lens group LG1, and the lenses made of a plastic material may be disposed continuously in the second lens group LG2. In the optical system 100, the lenses made of a glass material of the second lens group LG2 may be disposed between the lenses made of a plastic material of the first lens group LG1 and the lenses made of a plastic material of the second lens group LG2. The plastic lenses may be implemented in a lightweight manner, inexpensive, easy to design aspherical surfaces, and easy to remove chromatic aberration.

According to the embodiment of the present invention, the first lens 110 of the first lens group LG1 may be a lens made of a glass material, the second lens 120 and the third lens 130 may be lenses made of a plastic material, the fourth lens 140 of the second lens group LG2 may be a lens made of a glass material, and the fifth lens 150 and the sixth lens 160 may be lenses made of a plastic material. Each of the lenses includes an object-side surface and an image-side surface. The object-side surface and the image-side surface of the lens made of a glass material may both be spherical surfaces, and the object-side surface and the image-side surface of the lens made of a plastic material may both be aspherical surfaces. According to the embodiment of the present invention, since the number of aspherical surfaces in the optical system 100 is greater than the number of spherical surfaces, various aberrations may be corrected.

Referring to FIGS. 1 to 4, according to the embodiment of the present invention, among the first to sixth lenses included in the optical system 100, the first lens 110 disposed closest to the object side may have the maximum refractive index. For example, the refractive index of the first lens 110 may be 1.7 or more. Accordingly, the chromatic dispersion of light incident on the first lens 110 may increase, the center thickness may be made thinner than the edge thickness, the radius of curvature of the second and subsequent lenses may be easily changed, and the center thickness may increase.

Similarly, among the fourth to sixth lenses included in the second lens group LG2, the fourth lens 140 disposed closest to the object side may have the maximum refractive index. For example, the refractive index of the fourth lens 140 may be 1.7 or more. Accordingly, the chromatic dispersion of light incident on the fourth lens 140 may increase.

The first lens group LG1 may have negative power, and the second lens group LG2 may have positive power. Among the lenses of the first lens group LG1, the lens closest to the object side may have negative power, and among the lenses of the second lens group LG2, the lens closest to the sensor side may have positive power. When a focal length is expressed as an absolute value, a focal length of the first lens group LG1 may be greater than a focal length of the second lens group LG2, for example, 1. 1 to 2 times, preferably 1.1 to 1.5 times, and more preferably 1.1 to 1.3 times the focal length of the second lens group LG2. When expressed as an absolute value, an effective focal length (EFL) of the optical system 100 may be smaller than the focal length of the first lens group LG1. The effective focal length (EFL) of the optical system 100 may be smaller than an absolute value of the focal length of the second lens group LG2.

The number of lenses with positive power in the optical system 100 may be the same as the number of lenses with negative power.

The first lens 110 may be a glass lens, may have negative power, and may include an object-side surface 112 and an image-side surface 114, and the object-side surface 112 of the first lens 110 may be convex toward the object side and the image-side surface 114 may be concave toward the image side. Here, the convex surface of the lens may mean a lens surface having a convex shape in a region corresponding to the optical axis and the concave surface of the lens may mean a lens surface having a concave shape in the region corresponding to the optical axis. Here, the region corresponding to the optical axis may mean the optical axis or the paraxial region. Furthermore, the surface of the lens that is convex toward the object side may mean that the surface is concave toward the image side, and the surface of the lens that is convex toward the image side may mean that the surface is concave toward the object side.

The second lens 120 may have negative power and include an object-side surface 122 and an image-side surface 124, and the object-side surface 122 of the second lens 120 may be concave toward the object side and the image-side surface 124 may be concave toward the image side.

The third lens 130 may has positive power and include an object-side surface 132 and an image-side surface 134, and the object-side surface 132 of the third lens 130 may be convex toward the object side and the image-side surface 134 may be concave toward the image side.

The fourth lens 140 may have positive power and include an object-side surface 142 and an image-side surface 144, and the object-side surface 142 of the fourth lens 140 may be concave toward the object side, and the image-side surface 144 may be convex toward the image side.

The fifth lens 150 may have negative power and include an object-side surface 152 and an image-side surface 154, and the object-side surface 152 of the fifth lens 150 may be concave toward the object side and the image-side surface 154 may be concave toward the image side.

The sixth lens 160 may have positive power and include an object-side surface 162 and an image-side surface 164, and the object-side surface 162 of the sixth lens 160 may be convex toward the object side and the image-side surface 164 may be convex toward the image side.

According to the embodiment of the present invention, in the first lens group LG1, the first lens 110 and the second lens 120 may have negative power, and the third lens 130 may have positive power. The Abbe number of the third lens 130 in the first lens group LG1 may be smaller than the Abbe number of the first lens 110 and the Abbe number of the second lens 120. A difference between the Abbe number of the third lens 130 and the Abbe number of the first lens 110 or the second lens 120 may be 20 or more, preferably 25 or more. Accordingly, the chromatic aberration of the first lens group LG1 may be reduced by the third lens 130.

According to the embodiment of the present invention, in the second lens group LG2, the fourth lens 140 and the sixth lens 160 may have positive power, and the fifth lens 150 between the fourth lens 140 and the sixth lens 160 may have negative power. Further, in the second lens group LG2, the Abbe number of the fifth lens 150 may be smaller than the Abbe number of the fourth lens 140 and the Abbe number of the sixth lens 160. A difference between the Abbe number of the fifth lens 150 and the Abbe number of the fourth lens 140 or the sixth lens 160 may be 20 or more, preferably 25 or more. Accordingly, the fifth lens 150 may remove the chromatic aberration of the second lens group LG2.

According to the embodiment of the present invention, the Abbe number of the fourth lens 140 disposed between the third lens 130 and the fifth lens 150 for correcting chromatic aberration may be greater than the Abbe numbers of the third lens 130 and the fifth lens 150. For example, the Abbe number of the fourth lens 140 may be 20 or more, preferably 25 or more, greater than the Abbe numbers of the third lens 130 and the fifth lens 150. For example, the Abbe number of the fourth lens 140 may be about 49. Further, a difference between the maximum Abbe number and the minimum Abbe number in the optical system 100 may be 20 or more and 60 or less, preferably 25 or more and 50 or less, and more preferably 30 or more and 40 or less. Accordingly, an optical system capable of obtaining high-quality and high-pixel images, applicable to both visible light and IR light, and applicable to temperature changes of −40° C. to 85° C. may be obtained.

The optical system 100 according to the embodiment of the present invention may include an aperture Stop. The aperture may control an amount of light incident on the optical system 100. According to the embodiment of the present invention, the aperture Stop may be disposed between the first lens group LG1 and the second lens group LG2. That is, the aperture Stop may be disposed between the image-side surface 134 of the third lens 130 and the object-side surface 142 of the fourth lens 140.

For this purpose, the first lens group LG1 and the second lens group LG2 may have a predetermined gap on the optical axis OA. The optical axis gap between the first lens group LG1 and the second lens group LG2 on the optical axis OA may be an optical axis gap between the image-side surface of the lens that is closest to the sensor side among the lenses in the first lens group LG1 and the object-side surface of the lens that is closest to the object side among the lenses in the second lens group LG2. Here, among the lens surfaces of the first lens group LG1 and the second lens group LG2, two surfaces facing each other, for example, the image-side surface of the lens on the object side may be concave and the object-side surface of the lens on the sensor side may be concave. That is, the image-side surface 134 of the third lens 130 may be concave, and the object-side surface 142 of the fourth lens 140 may be concave. Accordingly, the first lens group LG1 may diffuse light incident through the object side, and the second lens group LG2 may refract the light diffused through the first lens group LG1 into the region of the image sensor 180.

As described above, the first lens group LG1 may have negative power, and the second lens group LG2 may have positive power. For example, the composite power of the first lens group LG1 is −0.23, and the composite power of the second lens group LG2 is 0.28. Accordingly, the first lens group LG1 may diffuse light incident through the object side, and the second lens group LG2 may refract the light diffused through the first lens group LG1 into the region of the image sensor 180.

According to the embodiment of the present invention, a ratio (R6/R7) of a radius of curvature R6 of the image-side surface 132 of the third lens 130 to a radius of curvature R7 of the object-side surface 141 of the fourth lens 140 may be −3 or less, preferably −5 or less, more preferably −8 or less. The sensitivity between the image-side surface 132 of the third lens 130 and the object-side surface 141 of the fourth lens 140 with the aperture disposed therebetween may be improved, and an divergence angle may be reduced. Particularly, the image-side surface 134 of the third lens 130 may have a concave but almost flat shape, which can reduce the divergence angle of light coming from the image-side surface 134 of the third lens 130. In addition, the object-side surface 142 of the fourth lens 140 with positive power may have a concave shape so that the incident angle is kept low, thereby reducing aberration.

According to the embodiment of the present invention, among the first to sixth lenses included in the optical system 100, the first lens 110 disposed closest to the object side may have a maximum effective diameter, and the effective diameter may tend to decrease from the object-side surface 112 of the first lens 110 to the image-side surface 134 of the third lens 130 and then increase from the object-side surface of the fourth lens 140 to the image-side surface of the sixth lens 160. According to the embodiment of the present invention, the first lens 110 may have the maximum effective diameter, and the effective diameters of the third to fifth lenses between the second lens 120 and the sixth lens 160 may be smaller than the effective diameter of the second lens 120 and the effective diameter of the sixth lens 160. Accordingly, since light incident on the optical system 100 tends to approach the optical axis and then move away from the optical axis, a stable optical path may be formed, and the light may evenly reach the periphery of the image sensor 180.

In addition, when the object-side surface 112 of the first lens 110 has the maximum effective diameter in the optical system 100, the amount of light incident on the optical system 100 may increase to improve the brightness of the optical system 100, the resolution of the optical system 100 and the deterioration of optical characteristics due to temperature changes may be compensated for, the chromatic aberration control characteristics may be improved, and the vignetting characteristics of the optical system 100 may be improved.

For example, an effective diameter ED_{LIS1} of the first lens 110 may be 8 mm or more, preferably 8 mm or more and 9.5 mm or less, and more preferably 8.5 mm or more and 9 mm or less.

According to the embodiment of the present invention, an effective diameter of the object-side surface 112 of the first lens 110 may be greater than a diagonal length of the image sensor 180. For example, the diagonal length 2*H_{imageD} of the image sensor 180 included in the optical system 100 according to the embodiment of the present invention may be 7.28 mm, a length of the image sensor 180 in the horizontal direction, that is, the X-axis direction, may be 5.76 mm, and a length of the image sensor 180 in the vertical direction, that is, the Y-axis direction, may be 4.46 mm. For example, a ratio of the effective diameter ED_{LIS1} of the object-side surface 112 of the first lens 110 to the diagonal length 2*H_{imageD} of the image sensor 180 may be 1.05 or more and 1.3 or less, preferably 1.1 or more and 1.2 or less, and more preferably 1.12 or more and 1.18 or less. When the effective diameter ED_{LIS1} of the first lens 110 and the diagonal length 2*H_{imageD} of the image sensor 180 satisfy the above numerical range, an amount of light incident on the object-side surface 112 of the first lens 110 may be maximized within the range in which the first lens 110 can be manufactured, and a field of view of 150 degrees or more may be implemented. When it is less than the lower limit of the above numerical range, it is difficult for a sufficient amount of light to reach the periphery of the image sensor at a field of view of 150 degrees or more, and when it exceeds the upper limit, there is a problem that it is difficult to manufacture the first lens and the size of the optical system 100 increases.

According to the embodiment of the present invention, the effective diameter ED_{LIS1} of the object-side surface 112 of the first lens 110 may be greater than the diagonal length of the image sensor 180, and the effective diameter ED_{LIS1} of the image-side surface 114 of the first lens 110 may be smaller than the diagonal length of the image sensor 180. For example, a ratio of an effective diameter ED_{LIS2} of the image-side surface 114 of the first lens 110 to the diagonal length 2*H_{imageD} of the image sensor 180 may be 0.4 or more and 0.7 or less, preferably 0.45 or more and 0.65 or less, and more preferably 0.5 or more and 0.6 or less. Accordingly, a field of view of the first lens 110 may be expanded. That is, it is possible to implement an optical system in which the field of view is 150 degrees or more and a ratio of an amount of light incident on the periphery of the image sensor to an amount of light incident on the center portion of the image sensor, that is, relative illumination (RI), is 50% or more, and in which the field of view is 170 degrees or more and the relative illumination is 30% or more. Here, the center portion of the image sensor means a region close to the 0 field of the image sensor, and the periphery of the image sensor means a region close to the 1 field of the image sensor.

At this time, a ratio of the effective diameter ED_{LIS1} of the object-side surface 112 of the first lens 110 to the effective diameter ED_{LIS1} of the image-side surface 114 of the first lens 110 may be 1.5 or more and 3 or less, preferably 1.7 or more and 2.6 or less, and more preferably 1.9 or more and 2.3 or less. At this time, a ratio (R1/R2) of a radius of curvature R1 of the object-side surface 112 of the first lens 110 to a radius of curvature R2 of the image-side surface 114 of the first lens 110 may be 3 to 4.5, preferably 3.25 to 4.25, and more preferably 3.5 to 4. Accordingly, the field of view of the first lens 110 may be expanded. That is, it is possible to implement an optical system with a field of view of 150 degrees or more and an RI of 50% or more, and a field of view of 170 degrees or more and an RI of 30% or more.

According to the embodiment of the present invention, the effective diameter ED_{LIS1} of the object-side surface 112 of the first lens 110 may be 0.2 to 1 times the TTL of the optical system, preferably 0.4 to 0.8 times, and more preferably 0.5 to 0.7 times. When the effective diameter ED_{LIS1} and TTL of the first lens 110 satisfy the above numerical range, the overall size of the optical system 100 may be balanced, and manufacturing is easy.

A center thickness CT of the object-side surface 112 of the first lens 110 represents a distance from the object-side surface 112 to the image-side surface 114 of the first lens 110. For example, the center thickness of the object-side surface 112 of the first lens 110 may represent a distance between the center of curvature of the object-side surface 112 and the center of curvature of the image-side surface 114 in the first lens 110. A center distance CG of the image-side surface 114 of the first lens 110 represents a distance from the image-side surface 114 of the first lens 110 to the object-side surface 122 of the second lens 120. Specifically, the center distance of the image-side surface 114 of the first lens 110 represents a center distance between the center of curvature of the image-side surface 114 of the first lens 110 and the center of curvature of the object-side surface 122 of the second lens 120, that is, an air gap.

According to the embodiment of the present invention, a ratio of an edge thickness ET1 to a center thickness CT1 of the first lens 110 may be 1.2 or more and 3 or less, preferably 1.3 or more and 2.5 or less, and more preferably 1.5 or more and 2 or less. Accordingly, it is possible to implement an ultra-wide-angle optical system with a field of view of 150 degrees or more and an RI of 50% or more, and a field of view of 170 degrees or more and an RI of 30% or more. Additionally, as described above, the first lens 110 is a glass lens. When the center thickness CT1 and the edge thickness ET1 in the first lens 110, which is a glass lens, satisfy the above conditions, the risk of breakage may be minimized even when it is disposed at the outermost side of the optical system 100 and exposed to an environment with frequent shaking and vibration, and it is easy to couple with the flange.

According to the embodiment of the present invention, among a first center distance CG1 between the first lens 110 and the second lens 120, a second center distance CG2 between the second lens 120 and the third lens 130, a third center distance CG3 between the third lens 130 and the fourth lens 140, a fourth center distance CG4 between the fourth lens 140 and the fifth lens 150, and a fifth center distance CG5 between the fifth lens 150 and the sixth lens 160, the second center distance CG2 may be the shortest. In this way, since the air gap on the object-side surface 132 side of the third lens 130, which plays a role in removing chromatic aberration, is minimized, the tolerance sensitivity and imaging performance of the optical system 100 may be improved.

According to the embodiment of the present invention, among the first center distance CG1 between the first lens 110 and the second lens 120, the second center distance CG2 between the second lens 120 and the third lens 130, the third center distance CG3 between the third lens 130 and the fourth lens 140, the fourth center distance CG4 between the fourth lens 140 and the fifth lens 150, and the fifth center distance CG5 between the fifth lens 150 and the sixth lens 160, the fourth center distance CG4 may be the next shortest distance after the second center distance CG2. In this way, since the air gap on the object-side surface 152 side of the fifth lens 150, which plays a role in removing chromatic aberration, is minimized, the tolerance sensitivity and imaging performance of the optical system 100 may be improved.

According to the embodiment of the present invention, among the first center distance CG1 between the first lens 110 and the second lens 120, the second center distance CG2 between the second lens 120 and the third lens 130, the third center distance CG3 between the third lens 130 and the fourth lens 140, the fourth center distance CG4 between the fourth lens 140 and the fifth lens 150, and the fifth center distance CG5 between the fifth lens 150 and the sixth lens 160, the first center distance CG1 may be the greatest. At this time, a ratio (R3/R2) of a radius of curvature R3 of the object-side surface 122 of the second lens 120 to the radius of curvature R2 of the image-side surface 114 of the first lens 110 may be −5 to −0.5, preferably −3 to −0.5, and more preferably −2 to −1. Further, a ratio (R3/R2/CG1) of the radius of curvature R3 of the object-side surface 122 of the second lens 120 to the radius of curvature R2 of the image-side surface 114 of the first lens 110 with respect to the center distance CG1 between the first lens 110 and the second lens 120 may be −5 to −0.1, preferably −3 to −0.2, and more preferably −2 to −0.5. Accordingly, the influence of ghosts of the first lens 110 and the second lens 120 on the entire optical system 100 may be minimized, and light output from the image-side surface 114 of the first lens 110 may be efficiently incident on the object-side surface 122 of the second lens 120 without loss.

According to the embodiment of the present invention, the third lens 130 may have the greatest center thickness among the first to sixth lenses. In this way, when the center thickness of the third lens 130 disposed in front of the aperture Stop and having positive refractive power is the greatest, an amount of light incident on the aperture Stop may be maximized. As described above, the third lens 130 is a plastic lens. When the third lens 130 having the greatest center thickness among the first to sixth lenses is a plastic lens, the weight of the entire optical system 100 may be reduced.

According to the embodiment of the present invention, a center thickness CT3 of the third lens 130 may be 0.25 times or more and 0.45 times or less the sum of the center thicknesses CT_16 of the first lens 110 to the sixth lens 160, preferably 0.28 times or more and 0.4 times or less, and more preferably 0.3 times or more and 0.36 times or less. The third lens may play a role in condensing light and correcting chromatic aberration and maximize the amount of light incident on the aperture Stop.

According to the embodiment of the present invention, the center thickness CT3 of the third lens 130 may be twice or more, preferably three times or more, and more preferably 3.5 times or more, a center thickness CT2 of the second lens 120. Accordingly, since alignment between the optical axis of the second lens 120 and the optical axis of the third lens 130 is easy, assemblability may be improved. In addition, when the center thickness of the third lens 130 having positive refractive power is twice or more the central thickness of the second lens 120 having negative refractive power, chromatic aberration may be efficiently removed from the third lens 130.

According to the embodiment of the present invention, the sixth lens 160 may have the next greatest center thickness after the third lens 130 among the first to sixth lenses. In this way, when the center thickness of the sixth lens 160 that is disposed closest to the image sensor 180 and has positive refractive power is great, an amount of light incident on the image sensor 180 may be maximized. As described above, the sixth lens 160 is a plastic lens. When the sixth lens 160 having the second greatest center thickness among the first to sixth lenses is a plastic lens, the weight of the entire optical system 100 may be reduced.

According to the embodiment of the present invention, a ratio (f5/f6) of an effective focal length f5 of the fifth lens 150 to an effective focal length f6 of the sixth lens 160 may be less than −1.02 and −0.95 or less, preferably −1.015 or more and −0.97 or less, and more preferably −1.015 or more and −0.98 or less. Accordingly, the tolerance sensitivity and overall optical imaging performance of the optical system 100 may be improved to increase productivity.

According to the embodiment of the present invention, a ratio (CG5/(CT5+CT6)) of the center distance CG5 between the fifth lens 150 and the sixth lens 160 to the sum of a center distance CT5 of the fifth lens 150 and a center distance CT6 of the sixth lens 160 may be 0.02 or more and 0.07 or less, preferably 0.04 or more and 0.065 or less, and more preferably 0.05 or more and 0.06 or less. Accordingly, the tolerance sensitivity and overall optical imaging performance of the optical system 100 may be improved to increase productivity.

According to the embodiment of the present invention, a ratio (F456/F) of an effective focal length F456 of the fourth to sixth lenses to an effective focal length F of the optical system 100 may be 1.5 or more and 1.665 or less, preferably 1.55 or more and 1.665 or less, and more preferably 1.6 or more and 1.665 or less. Accordingly, the tolerance sensitivity and overall optical imaging performance of the optical system 100 may be improved to increase productivity.

According to the embodiment of the present invention, the TTL, which is a distance from the object-side surface 112 of the first lens 110 to the image sensor 180, is 10 mm to 18 mm, preferably 12 mm to 16 mm, and more preferably 13 mm to 15 mm. Further, the BFL, which is a distance from the image-side surface 164 of the sixth lens 160 to the image sensor 180, is 4 mm or more and 8 mm or less, preferably 5 mm or more and 7 mm or less, and more preferably 5.5 mm or more and 6.5 mm or less. Further, the diagonal length 2*H_{imageD} of the image sensor 180 is 7.28 mm. The BFL needs to be implemented to be 4 mm or more from the standpoint of those skilled in the art, taking assembly performance into consideration. For example, in the case of a camera device with an auto-focus function, the BFL needs to be implemented to be 4 mm or more for the assembly of the optical system and the image sensor.

According to the embodiment of the present invention, the total top length (TTL) in the optical system 100 may be 1.3 times or more and 2.5 times or less the diagonal length 2*H_{imageD} of the image sensor 180, preferably 1.5 or more and 2.3 times or less, more preferably 1.8 or more and 2.1 times or less. In the optical system 100, the effective focal length (EFL) may be 2 mm or more, preferably 2.1 mm or more, and the field of view (FOV) may be 150 degrees or more, preferably 170 degrees or more so that it can be provided as a standard optical system in a vehicle camera module. For example, the optical system according to the embodiment and the camera device including the same may be applied to a camera for an advanced driving assistance system (ADAS) provided inside or outside a vehicle.

Here, the length of the image sensor 180 is the maximum length in the diagonal direction orthogonal to the optical axis OA, and may be smaller than the effective diameter of the lens closest to the object in the first lens group LG1 and greater than the effective diameter of the lens closest to the sensor in the second lens group LG2. Here, the number of lenses having an effective diameter greater than the length of the image sensor 180 may be 1 to 3, and the number of lenses having an effective diameter smaller than the length of the image sensor 180 may be 3 to 5.

According to the embodiment of the present invention, the ratio of the TTL to the effective focal length F of the optical system 100 may be 6 or more and 7 or less, preferably 6.2 or more and 6.8 or less, and more preferably 6.4 or more and 6.6 or less. Accordingly, a compact and lightweight optical system 100 may be obtained.

According to the embodiment of the present invention, the ratio of the BFL to the TTL of the optical system 100 may be 0.35 or more and 0.5 or less, preferably 0.37 or more and 0.48 or less, and more preferably 0.4 or more and 0.45 or less. Accordingly, since not only may a compact and lightweight optical system 100 be obtained, but also the BFL, which is a distance between the image-side surface 164 of the sixth lens 160 and the image sensor 180, may be guaranteed, so that the assemblability and productivity of the optical system 100 may be improved, and the RI of the image sensor 180 may be improved.

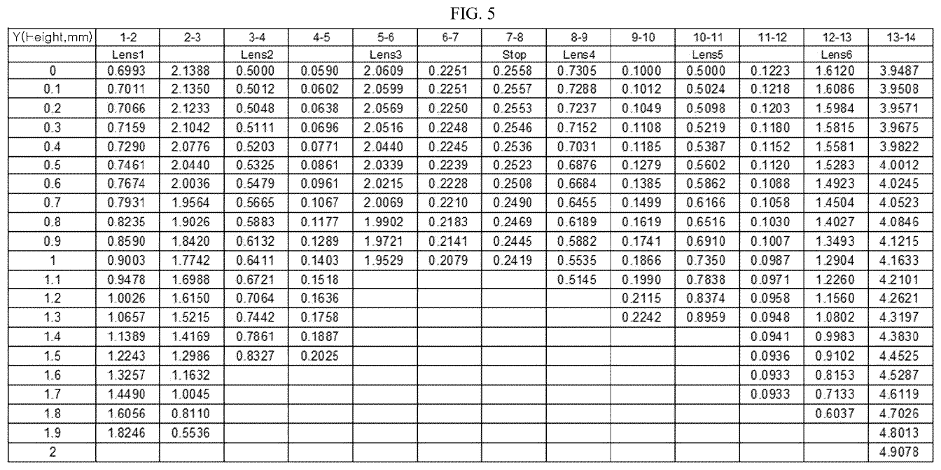

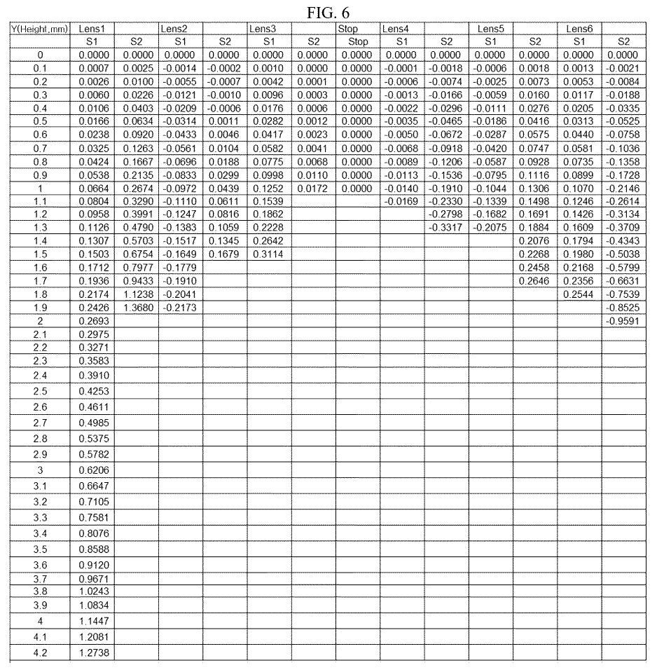

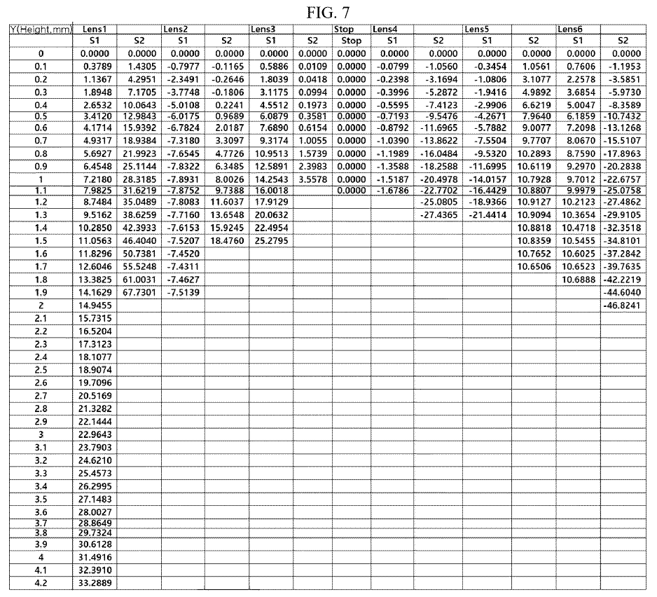

FIG. 5 is design data showing distances between lens surfaces according to distances in a Y direction from an optical axis in the optical system according to the embodiment of the present invention, FIG. 6 is design data showing sag values of lens surfaces according to distances in the Y direction from the optical axis in the first to sixth lenses of the optical system according to the embodiment of the present invention, and FIG. 7 is design data showing inclination angles of lens surfaces according to distances in the Y direction from the optical axis in the optical system according to the embodiment of the present invention. In FIGS. 5 to 7, L1, L2, L3, L4, L5, and L6 represent the first lens 110, the second lens 120, the third lens 130, the fourth lens 140, the fifth lens 150, and the sixth lens 160, respectively, S1 and S2 represent the object-side surface and the image-side surface, respectively, and L1S1, L1S2, L2S1, L2S2, L3S1, L3S2, L4S1, L4S2, L5S1, L5S2, L6S1, and L6S2 represent the object-side surface 112 and the image-side surface 114 of the first lens 110, the object-side surface 122 and the image-side surface 124 of the second lens 120, the object-side surface 132 and the image-side surface 134 of the third lens 130, the object-side surface 142 and the image-side surface 144 of the fourth lens 140, the object-side surface 152 and the image-side surface 154 of the fifth lens 150, and the object-side surface 162 and the image-side surface 164 of the sixth lens 160, respectively. The air between L1 and L2 represents a distance between the first lens 110 and the second lens 120, the air between L2 and L3 represents a distance between the second lens 120 and the third lens 130, the air between L3 and L4 represents a distance between the third lens 130 and the fourth lens 140, the air between L4 and L5 represents a distance between the fourth lens 140 and the fifth lens 150, and the air between L5 and L6 represents a distance between the fifth lens 150 and the sixth lens 160.

Referring to FIGS. 1 to 7, among the first center distance CG1 between the first lens 110 and the second lens 120, the second center distance CG2 between the second lens 120 and the third lens 130, the third center distance CG3 between the third lens 130 and the fourth lens 140, the fourth center distance CG4 between the fourth lens 140 and the fifth lens 150, and the fifth center distance CG5 between the fifth lens 150 and the sixth lens 160, the second center distance CG2 may be the smallest. At this time, a maximum distance D23_max between the second lens 120 and the third lens 130 with respect to the second center distance CG2 between the second lens 120 and the third lens 130 may be 1.01 times or more and 4 times or less. Accordingly, since the air gap on the object-side surface 132 side of the third lens 130, which plays a role in removing chromatic aberration, is minimized, and light output from the image-side surface 124 of the second lens 120 is incident almost perpendicularly on the object-side surface 132 of the third lens 130, the light is evenly refracted inside the third lens 130, and the chromatic aberration correction performance of the third lens 130 may be maximized.

According to the embodiment of the present invention, among the first center distance CG1 between the first lens 110 and the second lens 120, the second center distance CG2 between the second lens 120 and the third lens 130, the third center distance CG3 between the third lens 130 and the fourth lens 140, the fourth center distance CG4 between the fourth lens 140 and the fifth lens 150, and the fifth center distance CG5 between the fifth lens 150 and the sixth lens 160, the fourth center distance CG4 may be the next smallest distance after the second center distance CG2. At this time, a maximum distance D45_max between the fourth lens 140 and the fifth lens 150 with respect to the fourth center distance CG4 between the fourth lens 140 and the fifth lens 150 may be 1.01 times or more and 4 times or less. In this way, since the air gap on the object-side surface 152 side of the fifth lens 150, which plays a role in removing chromatic aberration, is minimized, and the light output from the image-side surface 144 of the fourth lens 140 is incident almost perpendicularly on the object-side surface 152 of the fifth lens 150, the light is evenly refracted inside the fifth lens 150, and the chromatic aberration correction performance of the fifth lens 150 may be maximized.

Meanwhile, the sag value refers to a distance on the optical axis between any point on the lens surface and a point on the optical axis. In this specification, Sagn1 may refer to a distance on the optical axis between any point on the object-side surface of an n^{th} lens and a point on the optical axis, and Sagn2 may refer to a distance on the optical axis between any point on the image-side surface of the n^{th} lens and a point on the optical axis. For example, Sag11 may refer to a distance on the optical axis between any point on the object-side surface 112 of the first lens 110 and a point on the optical axis, and Sag12 may refer to a distance on the optical axis between any point on the image-side surface 114 of the first lens 110 and a point on the optical axis. The sag value may mean an absolute value.

According to the embodiment of the present invention, at least one of the maximum sag value of the object-side surface 112 or the maximum sag value of the image-side surface 114 of the first lens 110 may be greater than the maximum sag values of the remaining lens surfaces in the optical system 100. For example, the maximum sag value of the object-side surface 112 and the maximum sag value of the image-side surface 114 of the first lens 110 may each be greater than the maximum sag values of the remaining lens surfaces in the optical system 100. For example, the maximum sag value of the object-side surface 112 and the maximum sag value of the image-side surface 114 of the first lens 110 may be 1 mm or more. As described above, since the first lens 110 is a glass lens, optical performance may be maintained even when it has a maximum sag value of 1 mm or more. When the maximum sag value of the object-side surface 112 and the maximum sag value of the image-side surface 114 of the first lens 110 are 1 mm or more, an ultra-wide-angle optical system of 150 degrees or more may be implemented.

Meanwhile, according to the embodiment of the present invention, at least one surface of at least one of the first to sixth lenses forming the optical system 100 includes a critical point. The critical point may mean a point where the trend of the sag value changes. The point where the trend of the sag value changes may be a point where the sag value increases and then decreases, or a point where the sag value decreases and then increases. The critical point may mean a point where the inclination angle becomes 0. The inclination angle may be defined as an angle formed by the normal to the tangent of the lens surface and the optical axis.

According to the embodiment of the present invention, at least one of the six surfaces of the first lens 110, the second lens 120, and the third lens 130 includes a critical point. Light is more effectively refracted near the critical point. That is, light passing through a lens surface including the critical point may be more effectively refracted compared to light passing through a lens surface not including the critical point. Thus, when at least one of the six surfaces of the first lens 110, the second lens 120, and the third lens 130 includes the critical point, light incident through the effective diameter of the object-side surface 112 of the first lens 110 may be refracted in the widest possible range between the first to third lenses, the light may uniformly reach the peripheral pixels of the image sensor 180 through the aperture Stop, and the performance of the optical system 100 may be enhanced.

For example, according to the embodiment of the present invention, the image-side surface 124 of the second lens 120 may include a critical point. More specifically, according to the embodiment of the present invention, the critical point of the image-side surface 124 of the second lens 120 may be a point having a vertical distance from the optical axis of 0.1 mm or more and 0.6 mm or less, preferably 0.2 mm or more and 0.5 mm or less, and more preferably 0.3 mm or more and 0.4 mm or less. For example, when the optical axis is a starting point and an end of the image-side surface 124 of the second lens 120 is an end point, the critical point of the image-side surface 124 of the second lens 120 may be disposed at a position that is 6% or more and 38% or less, preferably 12% or more and 32% or less, and more preferably 19% or more and 25% or less. Here, the end of the lens surface may mean an end of the effective region of the lens surface, and the position of the critical point may be a position set based on the direction perpendicular to the optical axis.

In this way, when critical points are present on one or more surfaces, for example, three surfaces, among the total six surfaces of the first to third lenses, light may be evenly distributed in the first to third lenses, output through the image-side surface 134 of the third lens 130, and incident on the object-side surface 142 of the fourth lens 140 through the aperture Stop.

As described above, the object-side surface 112 of the first lens 110 may have the greatest effective diameter among the first to sixth lenses included in the optical system 100, and the ratio of the effective diameter of the object-side surface 112 of the first lens 110 to the effective diameter of the image-side surface 114 of the first lens 110 may be 1.5 to 2.5, preferably 1.8 to 2.3, and more preferably 2 to 2.3, and the ratio (R1/R2) of the radius of curvature R1 of the object-side surface 112 of the first lens 110 to the radius of curvature R2 of the image-side surface 114 of the first lens 110 may be 3 to 4.5, preferably 3.25 to 4.25, and more preferably 3.5 to 4. At this time, the inclination angle of the image-side surface 114 of the first lens 110 may be 30 degrees or more in a region that is four times or more a distance from the optical axis to the critical point of the image-side surface 124 of the second lens 120. Accordingly, the field of view of the first lens 110 may be expanded. That is, it is possible to implement an optical system with a field of view of 150 degrees or more and an RI of 50% or more, and a field of view of 170 degrees or more and an RI of 30% or more.

According to the embodiment of the present invention, an optical system in which the image sensor has a horizontal angle of view of 150 degrees or more, a diagonal angle of view of 175 degrees or more, and an F number of 2.4 or less, for example, in the range of 1.4 to 2.4, for example, in the range of 1.8 to 2.3 may be obtained. At this time, the sensor length in the horizontal direction X may be 5.76 mm+0.5 mm, the sensor height in the vertical direction Y may be 4.46 mm=0.5 mm, and the sensor length in the diagonal direction may be 7.28 mm=0.5 mm. Accordingly, the change in focal point imaging position due to temperature changes may be suppressed, and a vehicle camera in which various aberrations are well corrected may be provided.

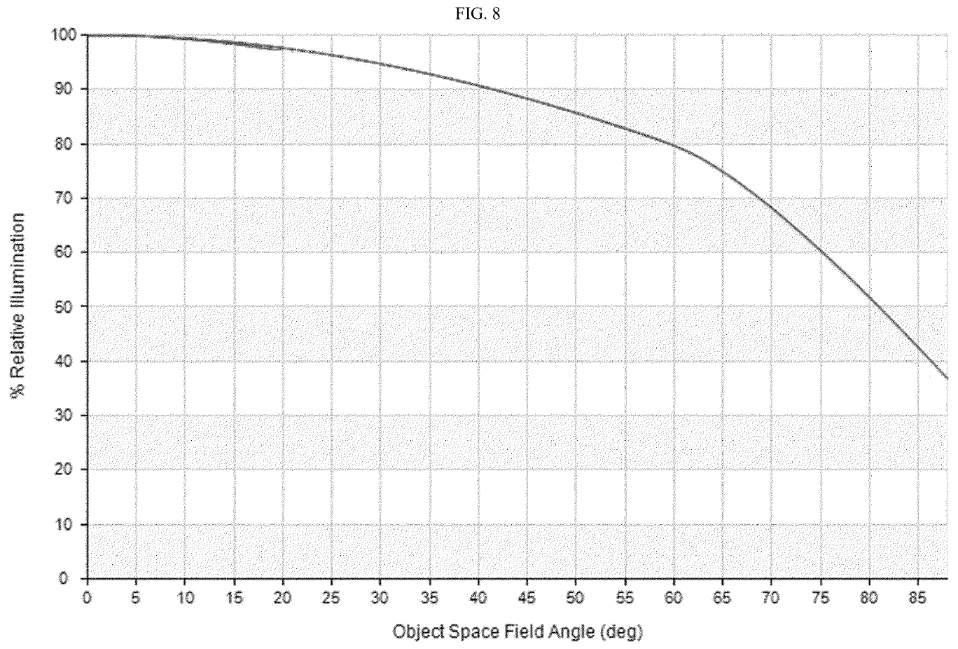

Table 1 is a table showing chief ray angle (CRA) data and RI data according to the position of the image sensor in the optical system according to the embodiment of the present invention, and FIG. 8 is a graph showing RI data according to the position of the image sensor in the optical system according to the embodiment of the present invention.

TABLE 1

| Field | CRA | RI (%) |
|---|---|---|
| 0 | 0.00 | 100.0 |
| 0.1 | 2.15 | 99.5 |
| 0.2 | 4.30 | 98.2 |
| 0.3 | 6.44 | 95.9 |
| 0.4 | 8.57 | 92.8 |
| 0.5 | 10.68 | 88.8 |
| 0.6 | 12.75 | 84.2 |
| 0.7 | 14.75 | 78.4 |
| 0.8 | 16.48 | 67.5 |
| 0.9 | 18.20 | 53.1 |
| 1 | 19.98 | 36.8 |

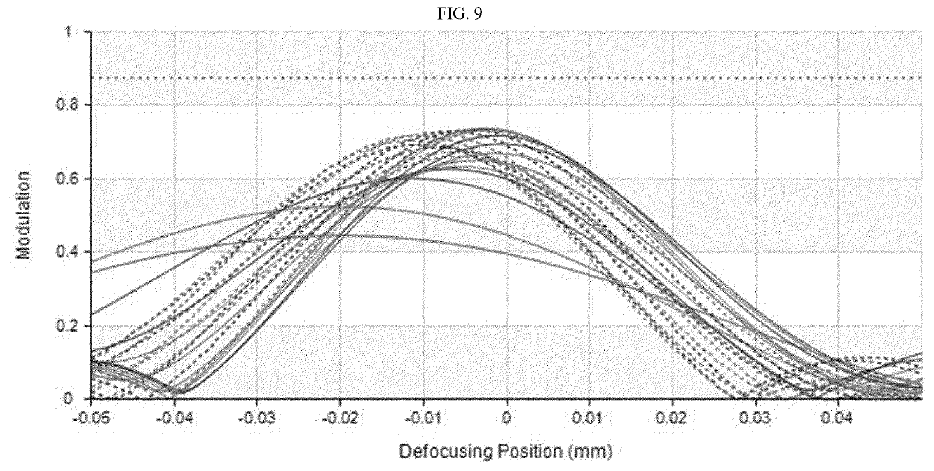

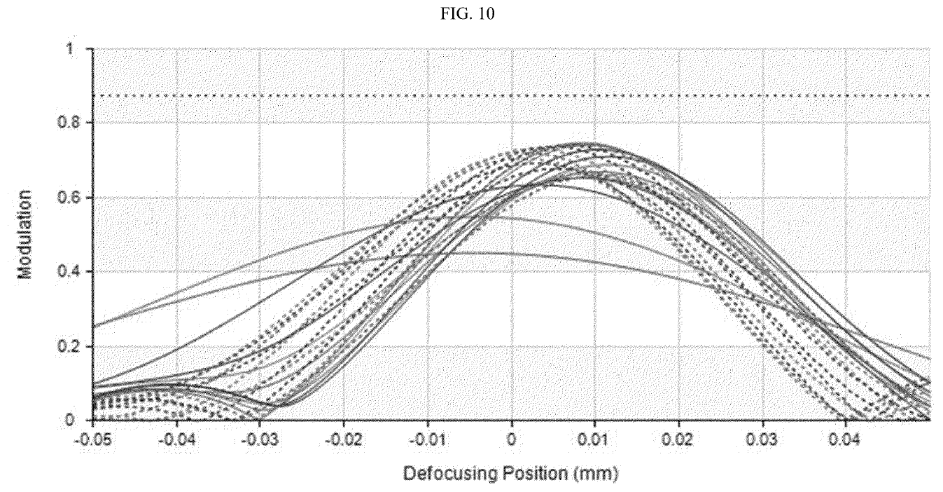

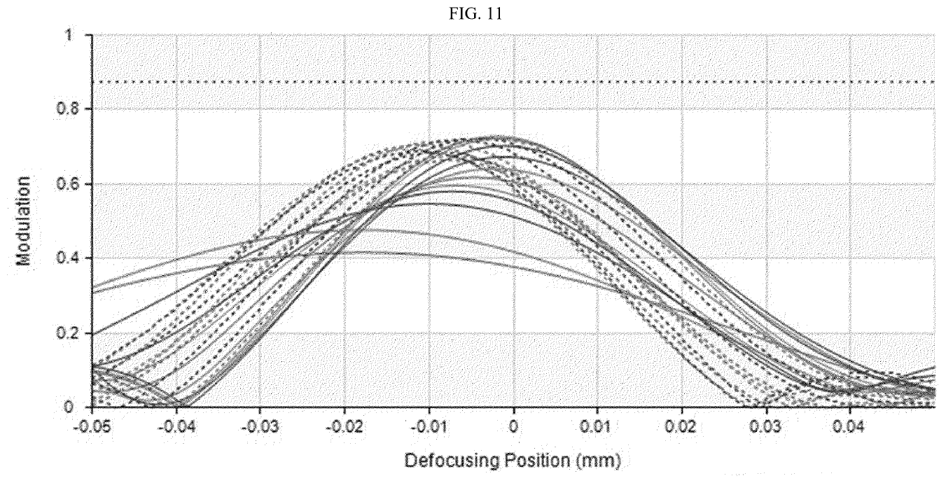

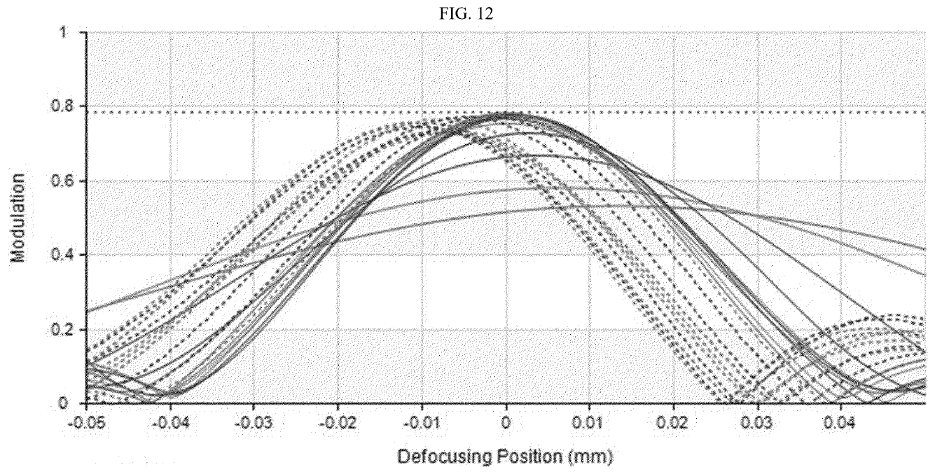

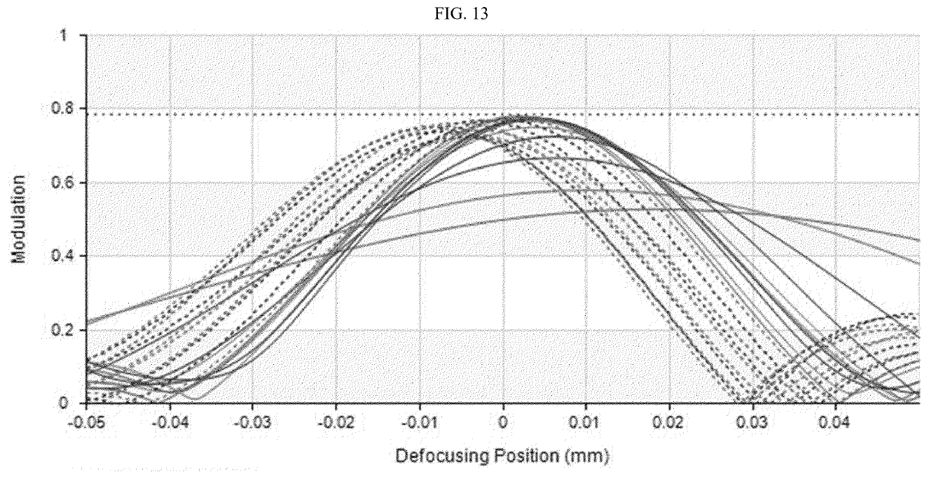

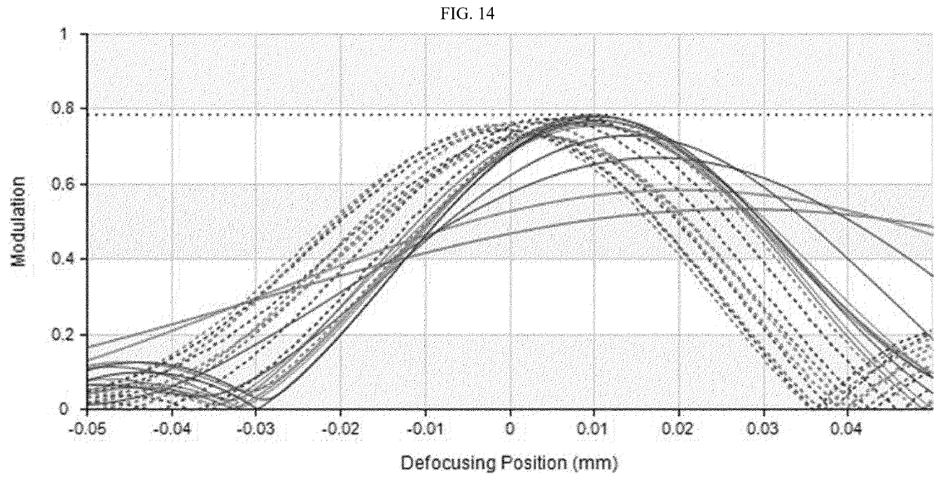

Referring to Table 1 and FIG. 8, in the optical system according to the embodiment of the present invention, the chief ray angle (CRA) may be 10 degrees or more, for example, in the range of 10 to 35 degrees or in the range of 10 to 25 degrees, at the 1 field, which is an end of the diagonal length of the image sensor. As shown in FIG. 8, a graph showing the relative illumination according to the image height in the optical system according to the embodiment is shown, and it can be seen that the relative illumination ratio from the center of the image sensor to the end of the diagonal is 36% or more. FIGS. 9 to 11 are graphs showing data on the diffraction modulation transfer function (MTF) of visible light at room temperature, low temperature, and high temperature in the optical system of FIG. 1, and FIGS. 12 to 14 are graphs showing data on the diffraction modulation transfer function (MTF) of IR light at room temperature, low temperature, and high temperature in the optical system of FIG. 1. Table 2 shows the diffraction modulation transfer function (MTF) values of visible light at room temperature, low temperature, and high temperature in the optical system of FIG. 1, and Table 3 shows the diffraction modulation transfer function (MTF) values of IR light at room temperature, low temperature, and high temperature in the optical system of FIG. 1. Here, room temperature is 22° C., low temperature is-40° C., and high temperature is 85° C. as an example.

TABLE 2

| Temperature | MTF (@801 ppm) | MTF deviation(@801 ppm) |
|---|---|---|
| (° C.) | center | center[mm] |
| 22 | 73.2 | −0.00255 |
| −40 | 68.2 | 0.00848 |
| 85 | 72.4 | 0.00204 |

TABLE 3

| Temperature | MTF (@801 ppm) | MTF deviation(@801 ppm) |
|---|---|---|
| (° C.) | center | center[mm] |
| 22 | 78.3 | −0.00005 |
| −40 | 77.7 | 0.00187 |
| 85 | 70.4 | 0.00966 |

FIGS. 9 to 11 are graphs showing the diffraction modulation transfer function (MTF) of visible light at room temperature, low temperature, and high temperature in the optical system of FIG. 1 and are graphs showing the luminance ratio (modulation) according to the spatial frequency. As shown in FIGS. 9 to 11 and Table 2, it can be seen that, in the embodiments of the present invention, the deviation of the MTF between low and high temperatures based on room temperature is low.

FIGS. 12 to 14 are graphs showing the diffraction modulation transfer function (MTF) of IR light at room temperature, low temperature, and high temperature in the optical system of FIG. 1 and are graphs showing the luminance ratio (modulation) according to the spatial frequency. As shown in FIGS. 12 to 14, it can be seen that, in the embodiments of the present invention, the deviation of the MTF at low or high temperature based on the room temperature is low.

In Table 4, changes in optical characteristics such as EFL, BFL, F number F #, TTL, and field of view (FOV) of visible light at room temperature, low temperature, and high temperature in the optical system according to the embodiment of the present invention are compared, and in Table 5, changes in optical characteristics such as EFL, BFL, F number F #, TTL, and field of view (FOV) of IR light at room temperature, low temperature, and high temperature in the optical system according to the embodiment of the present invention are compared.

TABLE 4

| | Room temperature | Low temperature | High temperature |
|---|---|---|---|
| | (22° C.) | (−40° C.) | (85° C.) |
| EFL | 2.15 | 2.14 | 2.16 |
| BFL | 5 | 4.98 | 5.01 |
| F# | 2.20 | 2.19 | 2.22 |
| TTL | 14 | 13.96 | 14.04 |
| FOV | 176 | 176.62 | 175.01 |

TABLE 5

| | Room temperature | Low temperature | High temperature |
|---|---|---|---|
| | (22° C.) | (−40° C.) | (85° C.) |
| EFL | 2.16 | 2.15 | 2.18 |
| BFL | 5 | 4.98 | 5.01 |
| F# | 2.20 | 2.19 | 2.22 |
| TTL | 14 | 13.96 | 14.04 |
| FOV | 174.94 | 175.78 | 173.75 |

Referring to Tables 4 and 5, it can be seen that not only in the visible light region but also in the IR light region, the change rate of the optical properties at low temperature is 5% or less, for example, 3% or less, based on room temperature, and the change rate of the optical properties at high temperature is 5% or less, for example, 3% or less, based on room temperature. Particularly, since the difference between the EFL and BFL according to temperature changes remains constant, temperature compensation is possible, thereby preventing a decrease in reliability of optical characteristics due to temperature changes.

The optical system 100 according to the embodiment of the present invention may satisfy at least one or two or more of the expressions described below. Accordingly, the optical system 100 according to the embodiment of the present invention may have improved optical characteristics. For example, when the optical system 100 according to the embodiment of the present invention satisfies at least one expression, the optical system 100 may effectively control aberration characteristics such as chromatic aberration and distortion aberration, and may have excellent optical performance not only at a center portion of the field of view (FOV) but also at the periphery thereof. Additionally, the optical system 100 may have improved resolution.

$$1 < {F}_{LG 1} / {F}_{LG 2} \qquad [ Expression 1 - 1 ]$$

$$1.1 \leq {F}_{LG 1} / {F}_{LG 2} \leq 2 \qquad [ Expression 1 - 2 ]$$

$$1.1 \leq {F}_{LG 1} / {F}_{LG 2} \leq 1.5 \qquad [ Expression 1 - 3 ]$$

$$1. 1 \leq {F}_{LG 1} / {F}_{LG 2} \leq 3 \qquad [ Expression 1 - 4 ]$$

Here, F_{LG1} is an effective focal length of the first lens group, and F_{LG2} is an effective focal length of the second lens group. When Expressions 1-1 to 1-4 are satisfied, the first lens group may diffuse light incident through the object side, and the second lens group may refract the light diffused through the first lens group into the region of the image sensor. When F_{LG1}/F_{LG2} is less than a lower limit of Expressions 1-1 to 1-4 or exceeds an upper limit, the RI of the image sensor may be significantly reduced or the quality may deteriorate.

$$V 3 < V 1 \qquad [ Expression 2 - 1 ]$$

$$V 3 < V 2 \qquad [ Expression 2 - 2 ]$$

$$V 5 < V 4 \qquad [ Expression 2 - 3 ]$$

$$V 5 < V 6 \qquad [ Expression 2 - 4 ]$$

$$V 3 = V 5 \qquad [ Expression 2 - 5 ]$$

Here, V1 is the Abbe number of the first lens 110, V2 is the Abbe number of the second lens 120, V3 is the Abbe number of the third lens 130, V4 is the Abbe number of the fourth lens 140, and V5 is the Abbe number of the fifth lens 150. When Expressions 2-1 to 2-5 are satisfied, the third lens 130 may remove the chromatic aberration of the first lens group, and the fifth lens 150 may remove the chromatic aberration of the second lens group.

$$20 \leq V max - V min \leq 60 \qquad [ Expression 3 - 1 ]$$

$$25 \leq V max - V min \leq 50 \qquad [ Expression 3 - 2 ]$$

$$30 \leq V max - V min \leq 40 \qquad [ Expression 3 - 3 ]$$

Here, Vmax is the maximum Abbe number among the first to sixth lenses, and Vmin is the minimum Abbe number among the first to sixth lenses. When Expressions 3-1 to 3-3 are satisfied, a high-quality and high-pixel image may be obtained, and the optical system applicable to both visible light and IR light and applicable to temperature changes of −40° C. to 85° C. may be obtained. When Vmax−Vmin is less than a lower limit of Expressions 3-1 to 3-3 or exceeds an upper limit, the optical characteristics may change depending on high temperature and low temperature environments, making it difficult to apply to a wide range of temperature changes.

$$R 6 / R 7 \leq - 3 \qquad [ Expression 4 - 1 ]$$

$$R 6 / R 7 \leq - 5 \qquad [ Expression 4 - 2 ]$$

$$- 10 \leq R 6 / R 7 \leq - 8 \qquad [ Expression 4 - 3 ]$$

Here, R6 is a radius of curvature of the image-side surface of the third lens 130, and R7 is a radius of curvature of the object-side surface of the fourth lens 140. When Expressions 4-1 to 4-3 are satisfied, the sensitivity between the image-side surface 132 of the third lens 130 and the object-side surface 141 of the fourth lens 140 may be improved, and the divergence angle may be reduced. When R6/R7 is less than a lower limit of Expressions 4-1 to 4-3 or exceeds an upper limit, the incident angle of the object-side surface 142 of the fourth lens 140 may increase, resulting in increased aberration.

$$8 mm \leq {ED}_{L 1 S 1} \qquad [ Expression 5 - 1 ]$$

$$8 mm \leq {ED}_{L 1 S 1} \leq 9.5 mm \qquad [ Expression 5 - 2 ]$$

$$8.5 mm \leq {ED}_{L 1 S 1} \leq 9 mm \qquad [ Expression 5 - 3 ]$$

Here, ED_{LIS1} is an effective diameter of the object-side surface of the first lens 110. When Expressions 5-1 to 5-3 are satisfied, the brightness of the optical system 100 may be improved by increasing the amount of light incident on the optical system 100, and the resolution of the optical system 100 and the deterioration of optical characteristics due to temperature changes may be compensated for. When ED_{LIS1} is less than a lower limit of Expressions 5-1 to 5-3, the amount of light incident on the optical system decreases, making it difficult to implement an ultra-wide-angle optical system, and when ED_{LIS1} exceeds an upper limit, there is a problem that the size of the optical system increases.

$$1.05 \leq {ED}_{L 1 S 1} / 2 * {H}_{imageD} \leq 1.3 \qquad [ Expression 6 - 1 ]$$

$$1.1 \leq {ED}_{L 1 S 1} / 2 * {H}_{imageD} \leq 1.2 \qquad [ Expression 6 - 2 ]$$

$$1.12 \leq {ED}_{L 1 S 1} / 2 * {H}_{imageD} \leq 1.18 \qquad [ Expression 6 - 3 ]$$

Here, H_{imageD} is half the diagonal length of the image sensor 180. When Expressions 6-1 to 6-3 are satisfied, an amount of light incident on the object-side surface 112 of the first lens 110 may be maximized within the range in which the first lens 110 may be manufactured, and a field of view of 150 degrees or more may be implemented. When ED_{LIS1}/2*H_{imageD} is less than a lower limit of Expressions 6-1 to 6-3, it is difficult for a sufficient amount of light to reach the periphery of the image sensor at a field of view of 150 degrees or more, and when ED_{LIS1}/2*H_{imageD} exceeds an upper limit, there is a problem that it is difficult to manufacture the first lens and the size of the optical system 100 increases.

$$0.4 \leq {ED}_{L 1 S 2} / 2 * {H}_{imageD} \leq 0.7 \qquad [ Expression 7 - 1 ]$$

$$0. 45 \leq {ED}_{L 1 S 2} / 2 * {H}_{imageD} \leq 0.65 \qquad [ Expression 7 - 2 ]$$

$$0.5 \leq {ED}_{L 1 S 2} / 2 * {H}_{imageD} \leq 0.6 \qquad [ Expression 7 - 3 ]$$

Here, ED_{LIS2} is the effective diameter of the image-side surface 114 of the first lens 110. When Expressions 7-1 to 7-3 are satisfied, the field of view of the first lens 110 may be widened. When ED_{LIS2}/2*H_{imageD} is less than a lower limit of Expressions 7-1 to 7-3 or exceeds the upper limit, it may be difficult for sufficient light to reach the periphery of the image sensor, or it may be difficult to implement a FOV of 150 degrees or more.

$$1.5 \leq {ED}_{L 1 S 1} / {BD}_{L 1 S 2} \leq 3 \qquad [ Expression 8 - 1 ]$$

$$1.7 \leq {ED}_{L 1 S 1} / {BD}_{L 1 S 2} \leq 2.6 \qquad [ Expression 8 - 2 ]$$

$$1.9 \leq {ED}_{L 1 S 1} / {BD}_{L 1 S 2} \leq 2.3 \qquad [ Expression 8 - 3 ]$$

When Expressions 8-1 to 8-3 are satisfied, the field of view of the first lens 110 may be widened. When ED_{LIS1}/ED_{LIS2} is less than a lower limit of Expressions 8-1 to 8-3 or exceeds an upper limit, it may be difficult for sufficient light to reach the periphery of the image sensor, or it may be difficult to implement a FOV of 150 degrees or more.

$$3 \leq R 1 / R 2 \leq 4.5 \qquad [ Expression 9 - 1 ]$$

$$3.25 \leq R 1 / R 2 \leq 4.25 \qquad [ Expression 9 - 2 ]$$

$$3. 5 \leq R 1 / R 2 \leq 4 \qquad [ Expression 9 - 3 ]$$

When Expressions 9-1 to 9-3 are satisfied, the field of view of the first lens 110 may be widened. When R1/R2 is less than a lower limit of Expressions 9-1 to 9-3 or exceeds an upper limit, it may be difficult for sufficient light to reach the periphery of the image sensor, or it may be difficult to implement a FOV of 150 degrees or more.

$$0.2 \leq {ED}_{L 1 S 1} / TTL \leq 1 \qquad [ Expression 10 - 1 ]$$

$$0. 4 \leq {ED}_{L 1 S 1} / TTL \leq 0.8 \qquad [ Expression 10 - 2 ]$$

$$0. 4 \leq {ED}_{L 1 S 1} / TTL \leq 0.8 \qquad [ Expression 10 - 3 ]$$

When ED_{LIS1}/TTL is less than a lower limit of Expressions 10-1 to 10-3 or exceeds an upper limit, it is difficult to balance the overall size of the optical system 100 and manufacturing may not be easy.

$$1.2 \leq ET 1 / CT 1 \leq 3 \qquad [ Expression 11 - 1 ]$$

$$1.3 \leq ET1 / CT 1 \leq 2.5 \qquad [ Expression 11 - 2 ]$$

$$1.5 \leq ET1 / CT 1 \leq 2 \qquad [ Expression 11 - 3 ]$$

Here, ET1 is an edge thickness of the first lens 110, and CT1 is a center thickness of the first lens 110. When Expressions 11-1 to 11-3 are satisfied, it is possible to implement an ultra-wide-angle optical system with a field of view of 150 degrees or more and an RI of 50% or more, and a field of view of 170 degrees or more and an RI of 30% or more. When ET1/CT1 is less than a lower limit of Expressions 11-1 to 11-3, coupling with the flange may be difficult and the risk of breakage of the first lens may increase, and when ET1/CT1 is exceeds an upper limit of Expressions 11-1 to 11-3, productivity may be reduced and coupling with the flange may be difficult.

$$- 5 \leq R 3 / R 2 \leq - 0.5 \qquad [ Expression 12 - 1 ]$$

$$- 3 \leq R 3 / R 2 \leq - 0.5 \qquad [ Expression 12 - 2 ]$$

$$- 2 \leq R 3 / R 2 \leq - 1 \qquad [ Expression 12 - 3 ]$$

Here, R2 is a radius of curvature of the image-side surface 114 of the first lens 110, and R3 is a radius of curvature of the object-side surface 122 of the second lens 120. When Expressions 12-1 to 12-3 are satisfied, the influence of the ghost of the first lens 110 and the second lens 120 on the entire optical system 100 may be minimized. When R3/R2 is less than a lower limit of Expressions 12-1 to 12-3 or exceeds an upper limit, some of the light output from the image-side surface 114 of the first lens 110 may be lost, thereby reducing imaging efficiency.

$$0.25 \leq CT 3 / CT\_ 16 \leq 0.45 \qquad [ Expression 13 - 1 ]$$

$$0.28 \leq CT 3 / CT\_ 16 \leq 0.4 \qquad [ Expression 13 - 2 ]$$

$$0.3 \leq CT 3 / CT\_ 16 \leq 0.36 \qquad [ Expression 13 - 3 ]$$

Here, CT3 is a center thickness of the third lens 130, and CT_16 is a total sum of center thicknesses of the first to sixth lenses. When Expressions 13-1 to 13-3 are satisfied, the third lens 130 may play a role in condensing light and correcting chromatic aberration and maximize the amount of light incident on the aperture Stop. When CT3/CT_16 is less than a lower limit of Expressions 13-1 to 13-3, the third lens 130 cannot sufficiently perform chromatic aberration correction, and when CT3/CT_16 exceeds an upper limit, an amount of light incident through the aperture may decrease.

$$2 \leq CT 3 / CT 2 \leq 10 \qquad [ Expression 14 - 1 ]$$

$$3 \leq CT 3 / CT 2 \leq 10 \qquad [ Expression 14 - 2 ]$$

$$3.5 \leq CT 3 / CT 2 \leq 10 \qquad [ Expression 14 - 3 ]$$

Here, CT2 is a center thickness of the second lens 120. When Expressions 14-1 to 14-3 are satisfied, since alignment between the optical axis of the second lens 120 and the optical axis of the third lens 130 is easy, assemblability may be improved. When CT3/CT2 is less than a lower limit of Expressions 14-1 to 14-3, it is difficult to efficiently remove chromatic aberration in the third lens 130, and when CT3/CT2 exceeds an upper limit, the overall size of the optical system 100 may excessively increase.

$$- 1.02 \leq f 5 / f 6 \leq - 0 \text{.95} \qquad [ Expression 15 - 1 ]$$

$$- 1.015 \leq f 5 / f 6 \leq - 0.97 \qquad [ Expression 15 - 2 ]$$

$$- 1.015 \leq f 5 / f 6 \leq - 0.98 \qquad [ Expression 15 - 3 ]$$

Here, f5 is an effective focal length of the fifth lens 150, and f6 is an effective focal length of the sixth lens 160. When Expressions 15-1 to 15-3 are satisfied, the tolerance sensitivity and overall optical imaging performance of the optical system 100 may be improved, thereby increasing productivity. When f5/f6 is less than a lower limit of Expressions 15-1 to 15-3 or exceeds an upper limit, since it deviates from an appropriate ratio between the effective focal length of the fifth lens 150 and the effective focal length of the sixth lens 160, imaging performance may deteriorate.

$$0.02 \leq CG 5 / ( CT 5 + CT 6 ) \leq 0 \text{.07} \qquad [ Expression 16 - 1 ]$$

$$0.04 \leq CG 5 / ( CT 5 + CT 6 ) \leq 0.065 \qquad [ Expression 16 - 2 ]$$

$$0.05 \leq CG 5 / ( CT 5 + CT 6 ) \leq 0.06 \qquad [ Expression 16 - 3 ]$$

Here, CG5 is a center distance between the fifth lens 150 and the sixth lens 160, CT5 is a center thickness of the fifth lens 150, and CT6 is a center thickness of the sixth lens 160. When Expressions 16-1 to 16-3 are satisfied, the tolerance sensitivity and overall optical imaging performance of the optical system 100 may be improved, thereby increasing productivity. When CG5/(CT5+CT6) is less than a lower limit of Expressions 16-1 to 16-3 or exceeds an upper limit, since the assemblability of the optical system 100 deteriorates, and it deviates from an appropriate ratio between the effective focal length of the fifth lens 150 and the effective focal length of the sixth lens 160, imaging performance may deteriorate.

$$1.5 \leq F 456 / F \leq 1.665 \qquad [ Expression 17 - 1 ]$$

$$1.55 \leq F 456 / F \leq 1.665 \qquad [ Expression 17 - 2 ]$$

$$1.6 \leq F 456 / F \leq 1.665 \qquad [ Expression 17 - 3 ]$$

Here, F456 is a composite effective focal length of the fourth to sixth lenses, and F is a total effective focal length of the optical system 100. When Expressions 17-1 to 17-3 are satisfied, the tolerance sensitivity and overall optical imaging performance of the optical system 100 may be improved, thereby increasing productivity. When F456/F is less than a lower limit of Expressions 17-1 to 17-3 or exceeds an upper limit, the assemblability of the optical system 100 may deteriorate and imaging performance may deteriorate.

$$1.3 \leq TTL / 2 * {H}_{i m a g e D} \leq 2.5 \qquad [ Expression 18 - 1 ]$$

$$1.5 \leq TTL / 2 * {H}_{i m a g e D} \leq 2.3 \qquad [ Expression 18 - 2 ]$$

$$1.8 \leq TTL / 2 * {H}_{i m a g e D} \leq 2.1 \qquad [ Expression 18 - 3 ]$$

When Expressions 18-1 to 18-3 are satisfied, a vehicle optical system having an effective focal length of 2 mm or more and a field of view of 150 degrees or more may be obtained. When TTL/2*H_{imageD} is less than a lower limit of Expressions 18-1 to 18-3, it may be difficult to obtain an effective focal length of 2 mm or more, and when TTL/2*H_{imageD} exceeds an upper limit, the total length of the optical system may become excessively great.

$$6 \leq TTL / F \leq 7 \qquad [ Expression 19 - 1 ]$$

$$6.2 \leq TTL / F \leq 6.8 \qquad [ Expression 19 - 2 ]$$

$$6.4 \leq TTL / F \leq 6.6 \qquad [ Expression 19 - 3 ]$$

When Expressions 19-1 to 19-3 are satisfied, a vehicle optical system having an effective focal length of 2 mm or more and a field of view of 150 degrees or more may be obtained. When TTL/F is less than a lower limit of Expressions 19-1 to 19-3, it may be difficult to obtain a field of view of 150 degrees or more, and when TTL/F exceeds an upper limit, the total length of the optical system may become excessively great.

$$0.35 \leq BFL / TTL \leq 0.5 \qquad [ Expression 20 - 1 ]$$

$$0.37 \leq BFL / TTL \leq 0.48 \qquad [ Expression 20 - 2 ]$$

$$0.4 \leq BFL / TTL \leq 0.45 \qquad [ Expression 20 - 3 ]$$

When Expressions 20-1 to 20-3 are satisfied, since not only can a compact and lightweight optical system 100 be obtained, but also the BFL, which is a distance between the image-side surface 164 of the sixth lens 160 and the image sensor 180, can be guaranteed, the assemblability and productivity of the optical system 100 may be improved, and the RI of the image sensor 180 may be improved. When BFL/TTL is less than a lower limit of Expressions 20-1 to 20-3, the assemblability of the optical system 100 may be limited, and when BFL/TTL exceeds an upper limit, the RI of the image sensor 180 may be reduced.

$$1.01 \leq D23\_max / CG 2 \leq 4 \qquad [ Expression 21 ]$$

Here, D23_max is the maximum distance between the second lens 120 and the third lens 130, and CG2 is a center distance between the second lens 120 and the third lens 130. When Expression 21 is satisfied, since an air gap on the object-side surface 132 side of the third lens 130, which plays a role in removing chromatic aberration, is minimized, and light output from the image-side surface 124 of the second lens 120 is incident almost perpendicularly on the object-side surface 132 of the third lens 130, the light may be evenly refracted inside the third lens 130, and the chromatic aberration correction performance of the third lens 130 may be maximized. When D23_max/CG2 is less than a lower limit of Expression 21, it is difficult to assemble the optical system, and when D23_max/CG2 exceeds an upper limit of Expression 21, it is difficult for light to be refracted evenly inside the third lens 130. Thus, the chromatic aberration correction performance of the third lens 130 may be reduced.

$$1.01 \leq D45\_max / CG 4 \leq 4 \qquad [ Expression 22 ]$$

Here, D45_max is the maximum distance between the fourth lens 140 and the fifth lens 150, and CG2 is a center distance between the fourth lens 140 and the fifth lens 150. When Expression 22 is satisfied, since an air gap on the side of the object-side surface 152 side of the fifth lens 150, which plays a role in removing chromatic aberration, is minimized, and light output from the image-side surface 144 of the fourth lens 140 is incident almost perpendicularly on the object-side surface 152 of the fifth lens 150, the light may be evenly refracted inside the fifth lens 150, and the chromatic aberration correction performance of the fifth lens 150 may be maximized. When D45_max/CG4 is less than a lower limit of Expression 22, it is difficult to assemble the optical system, and when D45_max/CG4 exceeds an upper limit of Expression 22, it is difficult for light to be refracted evenly inside the fifth lens 150. Thus, the chromatic aberration correction performance of the fifth lens 150 may be reduced.

$$1 mm \leq \vert max sag 11 \vert \qquad [ Expression 23 - 1 ]$$

$$1 mm \leq \vert max sag 12 \vert \qquad [ Expression 23 - 2 ]$$

Here, maxsag11 is the maximum sag value of the object-side surface 112 of the first lens 110, and maxsag12 is the maximum sag value of the image-side surface 114 of the first lens 110. When Expressions 23-1 and 23-2 are satisfied, an ultra-wide-angle optical system of 150 degrees or more may be implemented. When |maxsag11| or |maxsag12| is less than a lower limit of Expressions 23-1 and 23-2, it may be difficult to implement an ultra-wide-angle optical system of 150 degrees or more.

$$0.9 \leq \vert P 2 \vert / \vert P 3 \vert \leq 1.1 \qquad [ Expression 24 - 1 ]$$

$$0.915 \leq \vert P 2 \vert / \vert P 3 \vert \leq 1 \qquad [ Expression 24 - 2 ]$$

$$0.93 \leq \vert P 2 \vert / \vert P 3 \vert \leq 0.98 \qquad [ Expression 24 - 3 ]$$

Here, P2 is power of the second lens 120 and P3 is power of the third lens 130. As described above, the second lens 120 has negative power and the third lens 130 has positive power. When the powers of the second lens 120 and the third lens 130 satisfy Expressions 24-1 to 24-3, the chromatic aberration removal effect of the third lens 130 may be improved. When |P2|/|P3| is less than a lower limit of Expressions 24-1 to 24-3 or exceeds an upper limit, light may not be refracted efficiently in the third lens 130, and thus chromatic aberration removal performance may be reduced.

$$0.7 \leq \vert P 4 \vert / \vert P 5 \vert \leq 1 \qquad [ Expression 25 - 1 ]$$

$$0.75 \leq \vert P 4 \vert / \vert P 5 \vert \leq 0.9 \qquad [ Expression 25 - 2 ]$$

$$0.78 \leq \vert P 4 \vert / \vert P 5 \vert \leq 0.85 \qquad [ Expression 25 - 3 ]$$

Here, P4 is power of the fourth lens 140 and P5 is power of the fifth lens 150. As described above, the fourth lens 140 has negative power and the fifth lens 150 has positive power. When the powers of the fourth lens 140 and the fifth lens 150 satisfy Expressions 25-1 to 25-3, the chromatic aberration removal effect of the fifth lens 150 may be improved. When |P4|/|P5| is less than a lower limit of Expressions 25-1 to 25-3 or exceeds an upper limit, light may not be refracted efficiently in the fifth lens 150, and thus chromatic aberration removal performance may be reduced.

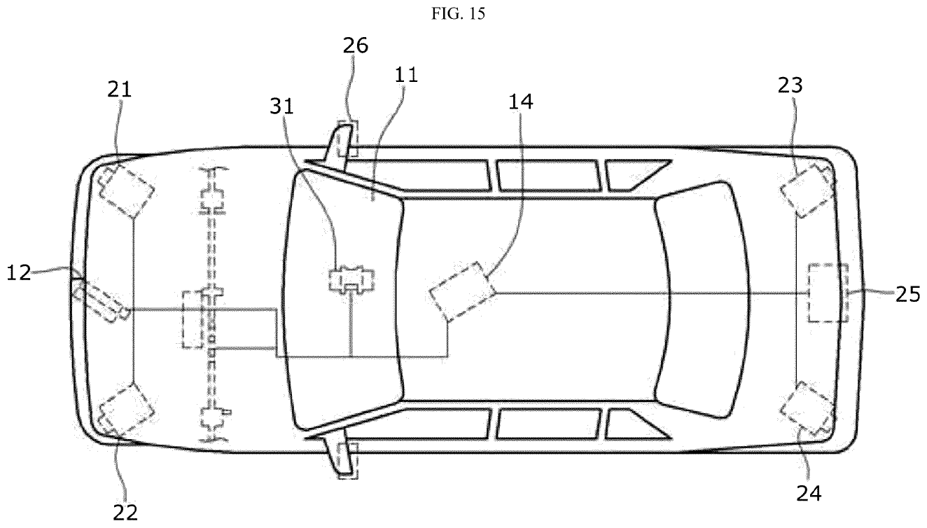

FIG. 15 is an example of a plan view of a vehicle to which the optical system according to the embodiment of the invention or the camera device including the same is applied.

Referring to FIG. 15, a vehicle camera system according to an embodiment of the present invention includes an image generating unit 11, a first information generating unit 12, second information generating units 21, 22, 23, 24, 25, and 26, and a control unit 14. The image generating unit 11 may include at least one camera module 31 disposed in the vehicle, and may capture images of the front of the vehicle and/or a driver to generate the images of the front of the vehicle or the interior of the vehicle. The image generating unit 11 may generate images of the surroundings of the vehicle by capturing the surroundings of the vehicle in one or more directions as well as the front of the vehicle using a camera device 31. Here, the front images and surrounding images may be digital images and may include color images, black and white images, infrared images, and the like. Additionally, the front and surrounding images may include still and moving images. The image generating unit 11 may provide the driver image, front images, and surrounding images to the control unit 14. Next, the first information generating unit 12 may include at least one radar and/or camera disposed in the vehicle, and detect the front of the vehicle to generate first detection information. Specifically, the first information generating unit 12 may be disposed in the vehicle and may detect the locations and speeds of vehicles, the presence and location of pedestrians, etc. located in front of the vehicle to generate the first detection information.

Using the first detection information generated by the first information generating unit 12, the distance between the vehicle and the preceding vehicle may be controlled to be maintained at a constant level, and the stability of vehicle operation may increase in specific preset cases, such as when the driver wants to change the driving lane of the vehicle or when parking in reverse. The first information generating unit 12 may provide the first detection information to the control unit 14. The second information generating units 21, 22, 23, 24, 25, and 26 may detect each side of the vehicle and generate second detection information based on the front images generated in the image generation unit 11 and the first detection information generated in the first information generating unit 12. Specifically, the second information generating units 21, 22, 23, 24, 25, and 26 may include at least one radar and/or camera disposed in the vehicle, and may detect the positions and speeds of vehicles located on the sides of the vehicle or capture images. Here, the second information generating units 21, 22, 23, 24, 25, and 26 may be disposed at the front corners, side mirrors, rear center, and rear corners of the host vehicle.

At least one information generating unit of these vehicle camera systems may include the optical system and the camera module having the same described in the embodiments disclosed above, and provide information acquired through the front, rear, each side, or corner regions of the vehicle using the information to a user or process the information to protect the vehicle and objects from autonomous driving or surrounding safety.

A plurality of optical systems of the camera device according to the embodiment of the invention may be mounted in the vehicle for safety regulations, enhancement of autonomous driving capabilities, and increased convenience. Additionally, the optical system of the camera device may be applied in the vehicle as a component for control such as the lane keeping assistance system (LKAS), lane departure warning system (LDWS), and driver monitoring system (DMS). This vehicle camera module may implement stable optical performance even under ambient temperature changes and provide price-competitive modules, thereby ensuring the reliability of vehicle components.

The features, structures, effects, etc. described in the embodiments above are included in at least one embodiment of the present invention, and are not necessarily limited to only one embodiment. Furthermore, the features, structures, effects, etc. exemplified in each of the embodiments may be combined or modified and implemented in other embodiments by a person having ordinary knowledge in the field to which the embodiments belong. Therefore, the contents related to these combinations and modifications should be interpreted as being included within the scope of the present invention.

In addition, although the description has been made focusing on examples above, these are merely examples and do not limit the present invention, and those with ordinary knowledge in the field to which the present invention belongs will recognize that various modifications and applications not exemplified above are possible without departing from the essential characteristics of the present invention. For example, each component specifically shown in the examples may be modified and implemented. Further, the differences related to these modifications and applications should be interpreted as being included within the scope of the present invention defined in the appended claims.

### REFERENCE NUMERALS

110: First Lens
120: Second Lens
130: Third Lens
140: Fourth Lens
150: Fifth Lens
160: Sixth Lens
170: Filter
180: Image sensor
190: Cover glass

1. An optical system comprising first to sixth lenses disposed sequentially from an object side to an image side, and an image sensor,
wherein the first lens has negative power, the second lens has negative power, the third lens has positive power, the fourth lens has positive power, the fifth lens has negative power, and the sixth lens has positive power,
an aperture is disposed between the third lens and the fourth lens,
the first to third lenses have negative composite power, and
the fourth to sixth lenses have positive composite power.

2. The optical system of claim 1, wherein an image-side surface of the third lens is concave, and an object-side surface of the fourth lens is concave.

3. The optical system of claim 2, wherein a ratio (R6/R7) of a radius of curvature (R6) of the image-side surface of the third lens to a radius of curvature (R7) of the object-side surface of the fourth lens is −3 or less.

4. The optical system of claim 1, wherein an effective diameter of an object-side surface of the first lens is 8 mm or more and 9.5 mm or less.

5. The optical system of claim 1, wherein an effective diameter of an object-side surface of the first lens is greater than a diagonal length of the image sensor, and an effective diameter of an image-side surface of the first lens is smaller than the diagonal length of the image sensor.

6. The optical system of claim 5, wherein a ratio of the effective diameter of the object-side surface of the first lens to the diagonal length of the image sensor is 1.05 or more and 1.3 or less, and a ratio of the effective diameter of the image-side surface of the first lens to the diagonal length of the image sensor is 0.4 to 0.7.

7. The optical system of claim 1, wherein at least one of an object-side surface and an image-side surface of the second lens includes a critical point having an inclination angle of 0, and
an inclination angle of an image-side surface of the first lens in a region that is four times or more a distance from an optical axis to the critical point is 30 degrees or more.

8. The optical system of claim 1, wherein a ratio of an edge thickness to a center thickness of the first lens is 1.2 or more and 3 or less.

9. The optical system of claim 1, wherein, among a first distance between the first lens and the second lens, a second distance between the second lens and the third lens, a third distance between the third lens and the fourth lens, a fourth distance between the fourth lens and the fifth lens, and a fifth distance between the fifth lens and the sixth lens, the second distance is the smallest.

10. The optical system of claim 9, wherein the fourth distance is the next smallest distance after the second distance.

11. The optical system of claim 1, wherein a ratio of a BFL to TTL (BFL/TTL) is 0.35 to 0.5.

12. The optical system of claim 1, wherein a ratio of a radius of curvature R1 of an object-side surface of the first lens to a radius of curvature R2 of an image-side surface of the first lens (R1/R2) is 3 to 4.5.

13. The optical system of claim 1, comprising a right-angled prism disposed at a front end of the first lens.

14. The optical system of claim 1, wherein an absolute value of a focal length of the first to third lenses is greater than an absolute value of a focal length of the fourth to sixth lenses.

15. The optical system of claim 14, wherein the absolute value of the focal length of the first to third lenses is 1.1 to 2 times the absolute value of the focal length of the fourth to sixth lenses.

16. The optical system of claim 1, wherein at least one of six surfaces of the first to third lenses includes a critical point.

17. The optical system of claim 1, wherein the first lens has a negative power, the second lens has a negative power, and the third lens has a positive power.

18. The optical system of claim 1, wherein the fourth lens has a positive power, the fifth lens has a negative power, and the sixth lens has a positive power.

19. The optical system of claim 1, wherein a ratio of an edge thickness to a center thickness of the first lens is 1.2 or more and 3 or less.

20. A camera apparatus comprising an optical system including first to sixth lenses disposed sequentially from an object side to an image side, and an image sensor,
wherein the first lens has negative power, the second lens has negative power, the third lens has positive power, the fourth lens has positive power, the fifth lens has negative power, and the sixth lens has positive power,
wherein an aperture is disposed between the third lens and the fourth lens,
wherein the first to third lenses have negative composite power, and
wherein the fourth to sixth lenses have positive composite power.
